(19) United States
(12) Patent Application Publication
(10) Pub. No.: US 2008/0271424 A1
(43) Pub. Date: Nov. 6, 2008

(54) Top unloading fixed line trimmer head

(76) Inventor: George E. Alliss, Lumberton, NC (US)

Correspondence Address: DAVID LEWIS, 1250 AVIATION AVE., SUITE 200B, SAN JOSE, CA, 95110, US

(21) Appl. No.: 12/151,064

(22) Filed: May 1, 2008

Related U.S. Application Data
(60) Provisional application No. 60/924,120, filed on May 1, 2007.

(51) Int. Cl. A01D 34/00

(52) U.S. Cl. 56/12.7

(57) ABSTRACT

In an embodiment, a fixed line trimmer head is configured such that the trimmer head is not loaded or unloaded from the bottom. In an embodiment, the trimmer head is loaded from the periphery and unloaded from the top.

In and embodiment, the trimmer head may include a gripping mechanism that is located near enough to the center of the trimmer head such that if the trimmer line breaks, the trimmer head does not become imbalanced to the point of vibrating.

In an embodiment, a spacer is located below the trimmer head. In an embodiment, the spacer has a socket that is contoured to mate with a bolt head. The bolt is inserted into the socket, and through a hole at the bottom of the socket. As a result of the contoured socket, the spacer may be used instead of a wrench to screw the bolt to trimmer head.

### CROSS-REFERENCE TO RELATED APPLICATIONS

This application claims priority benefit of U.S. Provisional Patent Application No. 60/924,120, filed May 1, 2007, which is incorporated herein by reference.

### FIELD

The present invention is related to vegetation trimmers that use flexible trimmer line in general.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Flexible line rotary trimmers are commonly used for cutting vegetation such as grass and weeds, particularly along walks, fences, flower beds, and around trees. Flexible line rotary trimmers include a rotary driven head that carries one or more lengths of monofilament line mounted within a housing. End portions of each line extend and project from the housings through guides in the side wall of the housing. As the trimmer head rotates at high speeds, the end portions of the trimmer line are caused to project outwardly from the housing by the centrifugal forces acting on the trimmer line, and the trimmer line functions as a cutting blade.

The majority of trimmer heads presently in use employ two separate monofilament lines which are wrapped about a common spool mounted within the head housing. The lines project from the spool and housing through diametrically opposed guides in the side wall of the trimmer housing. When the trimmer line projecting from the head breaks or becomes overly worn, fresh line must be extended from the head and the old line severed and discarded.

In what are commonly termed manual-type trimmer heads, the drive motor, which can be gas or electric, is shut down and a line indexing mechanism on the stationary trimmer head is actuated to pay out additional line from the trimmer head. Paying out additionally line may be accomplished by temporarily disengaging the spool from the head and rotating the spool a predetermined amount relative to the head. By simply pulling on the trimmer line, a measured length of fresh line is pulled from the spool, and the old line is severed and discarded.

In an effort to reduce the down time for line replacement, trimmer heads commonly referred to as “Bump and Feed” trimmer heads were developed in which the indexing mechanism is activated while the head is still rotating. A user simply presses and/or taps the rotating head against the ground or another solid body, while the motor is still running, which depresses an actuator button. Pressing on the button, temporarily disengages the trimmer line carrying spool from the housing, allowing the spool to rotate relative to the housing. The inertia of the line and centrifugal force acting on the line (pulling outward on the line) extending from the rapidly rotating head causes fresh trimmer line to be pulled from the spool and extended from the housing. A metering mechanism limits the relative rotation of the spool with respect to the housing and thus limits the length of the fresh lines paid out of the head. A line cutting blade is provided on as a part of a debris shield at a desired radial distance from the central axis of rotation which severs the worn lines, leaving the desired lengths of fresh line projecting from the head.

In an effort to further streamline the line replacement process, “Automatic Heads” were developed. Such trimmer heads typically include a spring biased pawl-type mechanism that reacts to an imbalance in the inwardly and outwardly directed forces acting on the rapidly rotating line that results from a loss of mass in the line extending from the head due to wear or breakage. The activation of the pawl mechanism temporarily disengages the spool from the housing allowing relative rotation between the spool and the housing, which causes a metered amount of trimmer line to be paid out. Excess material is again automatically severed by a knife guard as with the bump-feed type head.

While this evolution of the flexible line rotary trimmers from the manual head to the automatic head has significantly reduced operator time and effort in replacing worn and broken line, these advancements have met with some resistance. Each of these types of cutting heads requires the user to replace the line on the interior spool when the original supply has been consumed. For the casual home user of a trimmer machine this is a problem, because the trimmer head in most cases must be disassembled in order to correct problems. As some example of the types of problems that may require the home user to disassemble the head, the trimmer line at times becomes entangled on the spool. The tangling may be caused by the improper winding of trimmer line onto the spool, and/or the occurrence of the accumulation of line welds, excess dirt and debris within the trimmer head. The excess dirt and debris may also cause the head to jam. The trimmer line breaks off at the exit eyelet, and after breaking the trimmer line is drawn back into the spool compartment. Many trimmer heads have two separate trimmer lines that are each several feet in length, and that must be wrapped about the spool. If the trimmer line is not wrapped properly around the spool, the trimmer line may tangle within the trimmer head, and may interfere with the withdrawal of fresh trimmer line. The tangling of the trimmer line may require disassembly of the trimmer head, removal of the spool, rewinding of the line onto the spool, and reassembly of all disassembled components parts properly. Disassembly, winding of the spool, and reassembly of the trimmer head is cumbersome and requires a certain amount of dexterity and patience by the average operator, which makes the trimmer head difficult to use.

The more complicated the trimmer line feed mechanism; the more critical the proper winding of the trimmer line within the head becomes. Proper winding is particularly important in automatic heads where the slightest tangle can interfere with the functioning of the line pay out mechanism. Thus, there remains a need for a flexible line rotary trimmer head which greatly simplifies the task of line replacement for the home user.

Several attempts have been made to provide a more user-friendly rotary cutting head. Such heads typically employ one or more short lengths of trimmer line that are anchored within the head in lieu of the long lengths of trimmer line that are wrapped about an interior spool. These heads are frequently referred to as “Fixed Line Cutting Heads.”

While fixed line cutting heads have eliminated the need to carefully wrap a long length of line about the spools to prevent the tangles that cause trimmer line not to dispense from the “bump and feed” spool type trimmer head, many fixed line cutting heads still require disassembly and reassembly of trimmer head housing parts to replace worn or broken trimmer line. In some of these fixed line cutting heads removal of the worn trimmer line to replace it with a new fixed length of trimmer line can be difficult because the trimmer line is “jammed or wedged” so tight that a tool may be needed to aide in unjamming the trimmer line to be able to remove the trimmer line from the trimmer head.

A fixed line head which does not require disassembly to effect line replacement is found in U.S. Pat. No. 4,062,114, issued to Luick and entitled “Vegetation Cutting Apparatus.” The cutting heads disclosed therein are provided with one of several differently configured channels terminating in a reduced diameter portion proximate the side wall of the trimmer head. A short length of trimmer line extends through the channel and extends radially from the head. The line is held in place by an enlarged member secured to the inner end of the length of trimmer line which is translatable along the channel but cannot pass through the reduced diameter portion thereof. While such a trimmer head and trimmer line configuration provides for relatively simple trimmer line replacement, each length of replacement trimmer line must be provided with a suitable enlarged member at one end thereof, significantly increasing the cost of operation. In addition, if the trimmer line were to break at the eyelet or outlet end of the trimmer line channel, trimmer line removal may be difficult.

Listed below are examples that use a moveable metal clamping member that is spring biased for the purpose of holding a fixed length of monofilament trimmer line securely within a molded plastic/metal housing and can be mounted to a gas or electric powered vegetation trimmer machine (which may be handheld or may be of the wheeled type), U.S. Pat. Nos. 5,758,424 (Tacopa); 5,887,348 (Iacona); 5,896,666 (Iacona); 6,347,455 (Brant); 6,519,857 (Proulx); 6,581,292 (Alliss); 6,519,857 (Brant); 6,035,618 (Fogel); 6,944,956 (Fogel) and 7,111,403 (Moore) and the following US Published Patent Applications 2004/0128840 (Proulx), 2006/0048395 (Legrand), and 2006/0026846 (Alliss).

All of these particular fixed line trimmer heads listed above have one main objective in common, which is to provide an end user a fixed line trimmer head that is both easy to load and unload when compared to the difficulty in loading and unloading a “weave” type fixed line trimmer head. An example of a weave type fixed line trimmer head is U.S. Pat. No. 6,035,618 (Fogel).

Fogel's trimmer head holds a fixed trimmer line within the trimmer head housing without using a moveable clamping member that is spring biased for the purpose of holding one or more fixed lengths of monofilament trimmer line securely. In the Fogle '618 patent, the fixed line trimmer head requires both loading and unloading of the fixed length of trimmer line from the underside (which is the bottom) of the trimmer head housing, thus causing the trimmer head to be subject to the disadvantage of an awkward bottom unloading of trimmer line. One problem is that unloading the trimmer line from the bottom of the trimmer head, at least makes difficult and may preclude the utilization of a replaceable ground spacer that defines and regulates a cutting distance of the trimmer line from the ground surface.

A problem with grasping and gripping the end of the trimmer line by hand from the underside of the trimmer head to unload the trimmer line as shown in one or more embodiments of Iacona '666; '424; and '328; Alliss '292; Proulx '857 and Brant '455 is that the trimmer line is not easily accessible to an end user. The inaccessibility of the trimmer line makes it difficult to unload worn out fixed length trimmer lines and load new fixed lengths trimmer lines from the loading port located at the periphery of the vegetation trimmer.

It may be that during use, a vacuum is created, which may result from the large central opening in the cover. The vacuum may be adjacent the bottom cover of the head, which makes uniform cutting of vegetation more difficult.

Another issue with prior art trimmer heads, which the present inventors have recognized as a problem, is when one trimmer line of a two line head breaks off from the trimmer head, the vegetation trimmer will vibrate at a high frequency, because the trimmer head is unbalanced.

### SUMMARY OF INVENTION

In an embodiment, an easy loading and unloading fixed line trimmer head for string trimmer machines, that has trimmer line exit ports (which are used for “un-loading”) are located on the “top” side of the trimmer head housing instead of on the “bottom” side of the trimmer head housing.

Since the end of the fixed length of line exits from the “top” side instead of the “bottom” side of the trimmer head, a ground spacer can be utilized that defines and regulates a cutting distance of the trimmer line at which the trimmer head can glide and/or ride upon the ground surface freely. Additionally, significantly less debris (e.g., no debris) clogs the exit ports of the trimmer head.

In an embodiment, for each trimmer line the trimmer head includes a one-way gripping mechanism that prevents the trimmer line from exiting the trimmer head via the entrance ports. In an embodiment, the one-way gripping mechanism is located near the center of the trimmer head. As a result of locating the gripping mechanism near the center of the trimmer head and in contrast to prior art trimmer heads in which the gripping mechanism is located towards the outer periphery, if one trimmer line breaks off (even if the trimmer head has only one unbroken trimmer line left) the vegetation trimmer machine will not vibrate. By placing the one-way gripping mechanism near the center, the trimmer head can use one or more lines without causing any noticeable vibration caused by an imbalance resulting form one of the trimmer lines breaking or form trimmer lines no being evenly distributed about the trimmer head for other reasons

Any of the above embodiments may be used alone or together with one another in any combination. Embodiments of inventions described in this specification may not necessarily include any of the above embodiments.

### BRIEF DESCRIPTION OF THE DRAWINGS

In the following drawings like reference numbers are used to refer to like elements. Although the following figures depict various examples of the invention, the invention is not limited to the examples depicted in the figures.

FIG. 1 is an illustration of an example of a vegetation trimmer, according to the present invention.

FIG. 2 shows an embodiment of the trimmer head of the vegetation trimmer of FIG. 1.

FIG. 3 shows an exploded view of an embodiment of the trimmer head of FIG. 2.

FIG. 4 shows a cross section of an embodiment of the trimmer head of FIG. 2.

FIG. 5A shows an interior side of an embodiment of the bottom housing of the trimmer head of FIG. 2.

FIG. 5B shows an exterior side of an embodiment of bottom housing of the trimmer head of FIG. 2.

FIG. 6 shows an exterior side of an embodiment of the top housing of the trimmer head of FIG. 2.

FIG. 7 shows an interior side of an embodiment of the top housing of the trimmer head of FIG. 2.

FIG. 8 shows a bottom view of an embodiment of the spacer of FIG. 2.

FIG. 9 shows a flowchart of an embodiment of a method of assembling the trimmer head of FIG. 2.

FIG. 10 shows a flowchart of a method of an embodiment of loading trimmer line into the trimmer head of FIG. 2.

FIG. 11A shows a flowchart of an embodiment of a method of using trimmer head of FIG. 2.

FIG. 11B shows another embodiment of trimmer head.

FIG. 12 shows an exploded view of an embodiment of trimmer head.

FIG. 13 shows a cross section of an embodiment of the trimmer head.

FIG. 14A shows the interior side of the bottom of the housing.

FIG. 14B shows the exterior side of the bottom housing having the adaptor.

FIG. 14C shows the interior side of the bottom housing without the modules.

FIG. 15A shows an embodiment of the bottom sides of the modules.

FIG. 15B shows an embodiment of the top sides of the modules.

FIG. 15C shows an embodiment of the topside of the adaptor.

FIG. 15D shows an embodiment of the bottom side of adaptor.

FIG. 16 shows interior side of and embodiment of top housing.

### DETAILED DESCRIPTION OF THE INVENTION

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

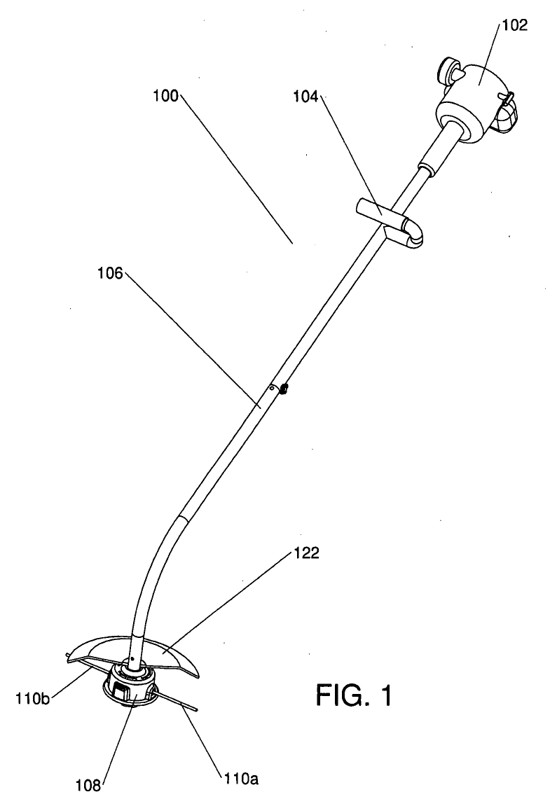

In general, at the beginning of the discussion of each of FIGS. 1-8 and 11B-16 is a brief description of each element, which may have no more than the name of each of the elements in the one of FIGS. 1-8 and 11B-16 that is being discussed. After the brief description of each element, each element is further discussed in numerical order. In general, each of FIGS. 1-16 is discussed in numerical order, and the elements within FIGS. 1-16 are also usually discussed in numerical order to facilitate easily locating the discussion of a particular element. Nonetheless, there is no one location where all of the information of any element of FIGS. 1-16 is necessarily located. Unique information about any particular element or any other aspect of any of FIGS. 1-16 may be found in, or implied by, any part of the specification. Additionally, after discussing each of FIGS. 1-16 in numerical order various aspects of various embodiments are further discussed to facilitate a better understanding these aspects (these aspects may or may not have been also discussed while discussing FIGS. 1-16).

### Vegetation Trimmer (FIG. 1)

FIG. 1 is an illustration of an example of a vegetation trimmer 100 according to the present invention. Vegetation trimmer 100 may include motor 102, steering handle 104, shaft 106, trimmer head 108, trimmer lines 110a and b, and optional shield 122. In other embodiments, vegetation trimmer 100 may not have all of the elements listed and/or may have other elements instead of, or in addition to, those listed.

Vegetation trimmer 100 may be a handheld device that is used for cutting vegetation or other material. Motor 102 powers vegetation trimmer 100. Motor 102 may be an electric motor, combustion engine, or another type of motor. Steering handle 104 may be used for holding, guiding, and directing the vegetation trimmer. Shaft 106 may also be used for holding vegetation trimmer 100. Shaft 106 may be hollow and, within the hollow portion, shaft 106 may contain a mechanical connection coupling motor 102 to a trimmer head (the mechanical connection may be referred to as a mechanical link and shaft 106 maybe referred to as a driveshaft).

Trimmer head 108 may connect, via the mechanical link, to shaft 106 at a distal end. Trimmer head 108 may be used with other types of trimmers other than vegetation trimmer 100. For example, although vegetation trimmer 100 is illustrated as a handheld machine, an embodiment of a trimmer head 108 may be used on a wheeled trimmer machine. As used herein, the terms “top” and “bottom” refer to the relative positions that the top and bottom of trimmer head 108 would assume when trimmer head 108 is “in use,” when attached to shaft 106 of vegetation trimmer 100.

Trimmer head 108 may hold trimmer lines 110a and b, and may include a spinning portion that causes trimmer lines 110a and b to rotate at a fast enough speed to cut vegetation. Trimmer lines 110a and b may be a flexible wire. For example, trimmer lines 110a and b may be a nylon wire or other type of wire. As trimmer head 108 spins trimmer lines 110a and b tend to extend radially outward as a result of the centrifugal force. Although only two trimmer lines 110a and b are shown, there may be any number of trimmer lines. In an embodiment, two oppositely directed trimmer lines 110a and b may be deployed in this fixed line cutting head.

In an embodiment, the trimmer lines are symmetrically spaced and/or equally spaced around the head. For example, if there are two trimmer lines, the two trimmer lines are placed 180 degrees apart, while if three trimmer lines are included, the trimmer lines may be placed 120 degrees apart. Furthermore, it will be understood that trimmer head 108 may include three or more equiangularly spaced passageways for accommodating a corresponding number of cutting members.

In an embodiment, trimmer lines 110a and b, may be any of a wide range of both different sizes (e.g., 0.047″ to 0.160″ in diameter) and of different shapes, such as having round or non-round cross sections (e.g., the trimmer line may have a cross section that has the shape of a square, octagon, hexagon, diamond, star, or oval). For example, each of trimmer lines 110a and b may be any trimmer line constructed as a flexible yet rugged filament, string, or wire. In an embodiment, trimmers lines 110a and b may be any of the commercially available flexible monofilament plastic trimmer line of any suitable type and cross-sectional configuration, such as 0.065″, 0.080″, 0.095″, 0.105″, 0.12″, 0.130″ or 0.155″ gauge nylon trimmer line or the like, which is currently used as cutting filaments in conventional vegetation trimmer.

Optionally, vegetation trimmer 100 may include shield 112 for the operator's safety. Shield 112 may protect the user from flying debris that may be kicked up by rotating trimmer lines 110a and b or trimmer head 108.

In an embodiment, trimmer head 108 is a fixed line trimmer head for a flexible line trimmers that does not require disassembly, which can be easily and quickly loaded as well as easily and quickly unloaded without the use of a separate tool. In an embodiment, a trimmer head 108 is for a flexible line rotary trimmers, and includes a simplified easy trimmer line removal, and trimmer head 108 is of simple construction and economical to manufacture. In an embodiment, trimmer head 108 is for a flexible trimmer line and simplifies easy trimmer line removal and replacement, which is adapted for use in heavy brush. In an embodiment, trimmer head 108 is for a flexible line rotary trimmer that has a simplified easy line removal and replacement while providing a tight securement of the line to the head independent of the rotational velocity of the head and is adaptable for use with trimmer line of a wide variety of diameters and round and non-round shapes (a securement is a means for securing).

In an embodiment, trimmer head 108 is for a flexible line rotary trimmer that has a simplified line removal and replacement that allows replacing trimmer lines 110a and b, without disassembling and reassembling trimmer head 108. In an embodiment, trimmer head 108 is for flexible line rotary trimmers, and trimmer head 108 is more durable than known arrangements, and trimmer head 108 reduces (e.g., minimizes) wear on the string during operation. In an embodiment, trimmer head 108 is for flexible line rotary trimmers that can be used on the majority of gas and electric manufactured handheld, wheeled, vegetation, and brush cutting machines (e.g., multi-fit) and is for use by both home owners or commercial owners. The tightness of the securement maybe dependent of the rotational velocity of the head. In an embodiment, trimmer head 108 includes a “one way” gripping device that may slide or pivot and may be spring biased.

In an embodiment, there are at least three forces that work together along with the serrated paws/teeth making contact with the nylon line which facilitate the functioning of the gripping mechanism clamps under the extreme conditions that facilitate holding a single strand of trimmer line in a trimmer head housing until it either wears down abrasively or pre-maturely breaks off at the eyelet and/or grommet. In this specification, the word “paw” is used to refer to the profile of the jagged edge or roughed surface of a cleat and the terms jagged edge and paw are interchangeable. Pre-mature breakage may be caused in part by high heat levels generated by constant and extreme bending of the flexible line. Heat may also be generated from trimmer line by high friction levels as a result of the trimmer line is making constant contact with the vegetation or hard objects.

One force is the spring (this force may be insignificant). The purpose of the spring is to hold the line in the channel and to prevent the trimmer line from falling out prior to the other two forces taking effect and holding the trimmer line in place.

A second force is the outward pull generated by centrifugal force upon the sliding or pivoting gripping members. In an embodiment, even at high rotational velocities the centrifugal force would not be great enough to hold a single strand of trimmer line in a trimmer head if not for a third force.

The third force is a combination of forces with a trimmer head trimmer line that turns at 8000 to 12,000 rpms while constantly contacting vegetation and hard objects, which creates a combination of high levels of pulling and frictional forces being applied to the extended length of trimmer line. In an embodiment, the third force is the dominant force that makes the mechanical one way gripping devices perform effectively under this extreme application and environment.

In an embodiment, teeth may be placed on the clamps of the gripping mechanism. The word teeth may be replaced by paw to obtain another embodiment. The design of the teeth and the sharpness of the teeth is a factor in the relationship to the performance of the particular type of clamping member being used. In other words, sliding wedges, sliding discs, pivoting cams may each use different types of teeth.

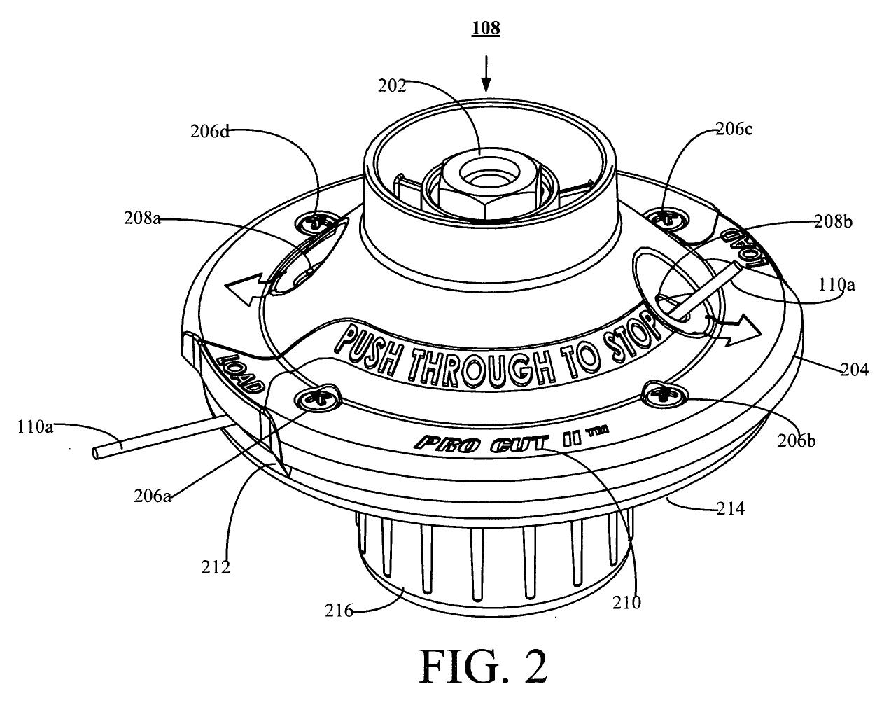

### Perspective View (FIG. 2)

FIG. 2 shows an embodiment of trimmer head 108. Trimmer head 108 includes driveshaft 202, and top housing 204 having screws 206a-d, exit ports 208a and b, and labels 210. Trimmer head 108 also includes, entrance port 212, bottom housing 214, and spacer 216. In other embodiments, trimmer head 108 may not have all of the elements listed and/or may have other elements instead of, or in addition to, those listed.

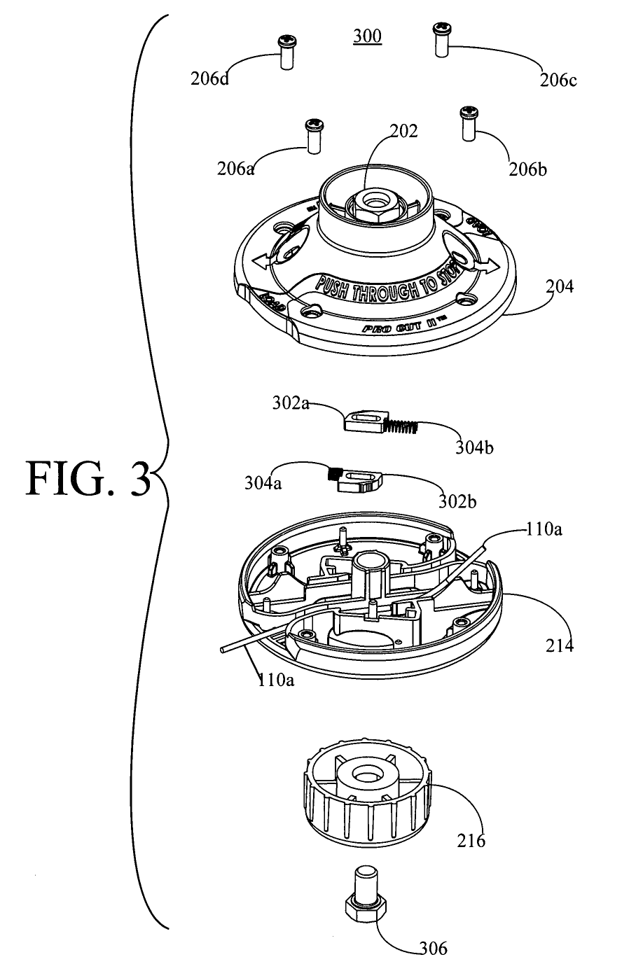

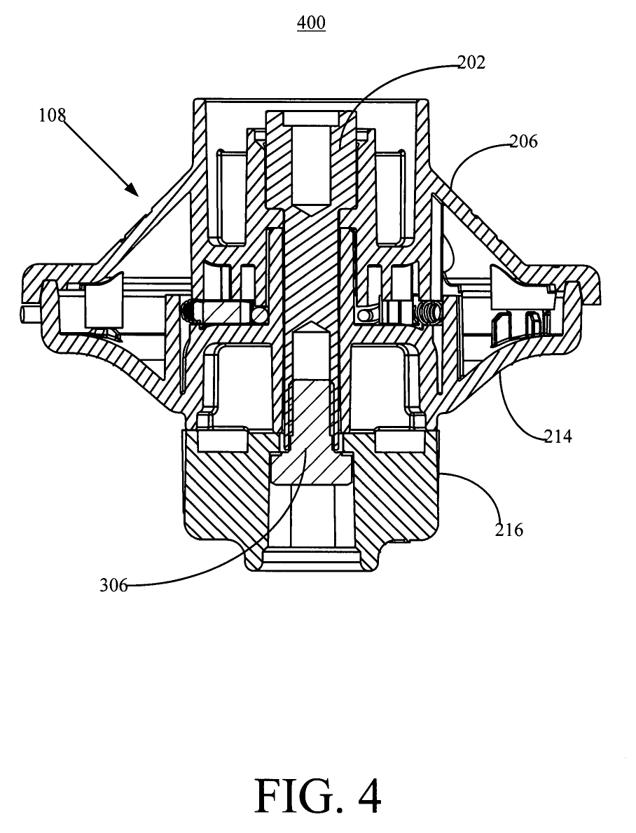

Driveshaft 202 holds trimmer head 108 together and connects trimmer head 108 to a mechanical link within shaft 106, which connects to motor 102. Driveshaft 202 is discussed further in conjunction with FIGS. 3 and 4.

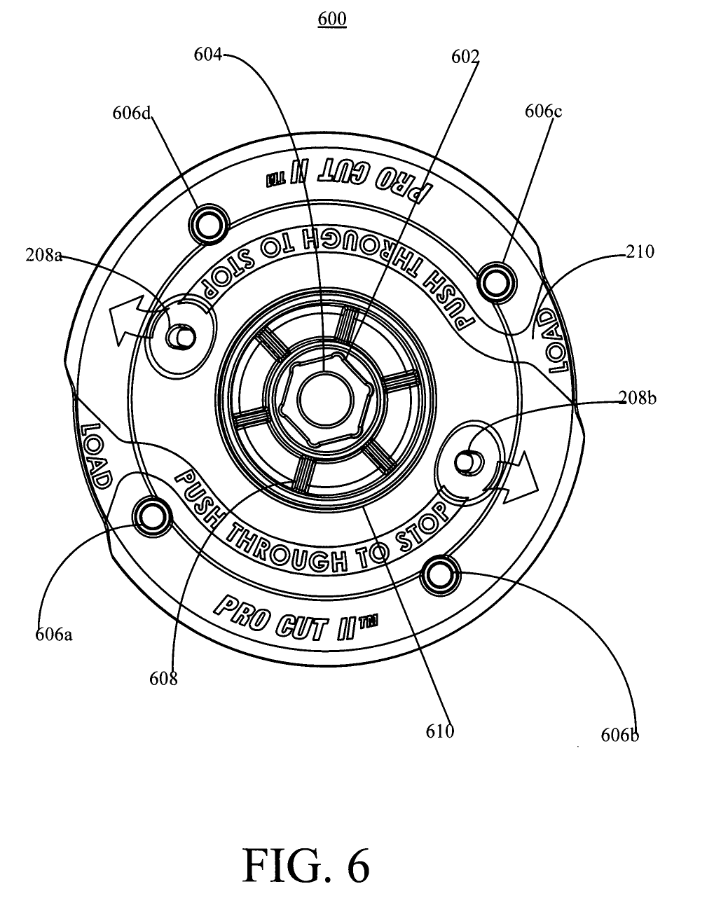

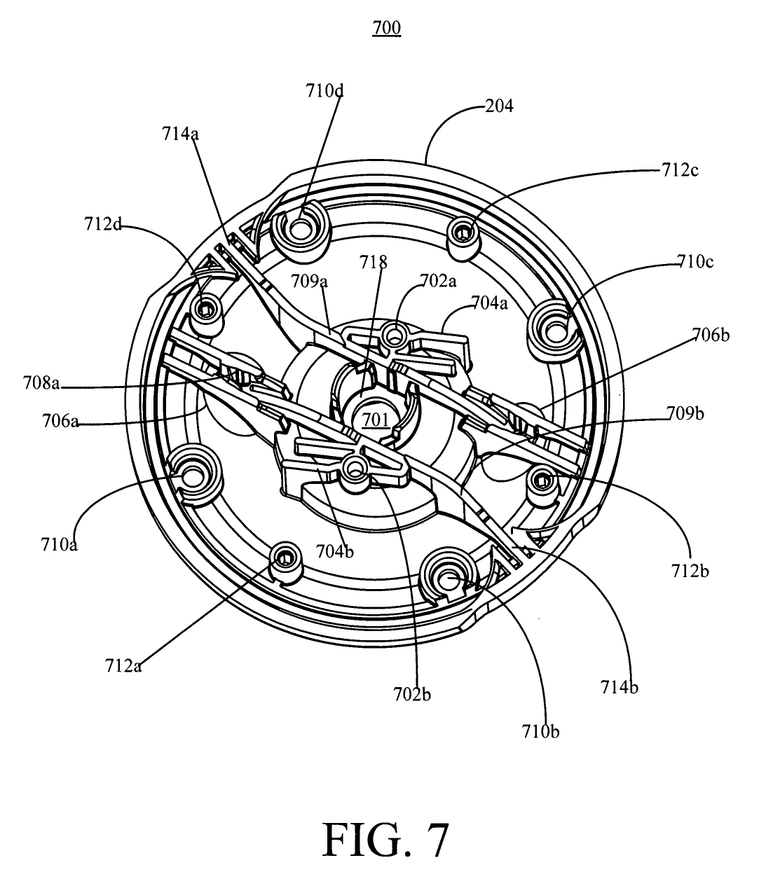

Top housing 204 covers trimmer head 108 preventing debris from entering trimmer head 108 via the top. The interior of top housing 204 is discussed further in conjunction with FIG. 6, below, and the exterior of top housing 204 is discussed further in conjunction with labels 210 and FIG. 7, below. Screws 206a-d help hold top housing 204 to the bottom housing of trimmer head 108. Any places in this specification where screws are discussed, the screws may be replaced with any fasteners. For examples, the screws may be replaced with snaps, rivets, clasps, tabs that interlock with holes, or any other means for fastening.

Exit ports 208a and b may be used for removing trimmer lines 110a and b from trimmer head 108 after trimmer lines 110a and b are worn. Exit ports 208a and b are placed in the top of top housing 204, instead of in the bottom of trimmer head 108, because entrance ports at the bottom of trimmer heads tend to get clogged with debris that is sucked up by the vacuum created under trimmer head 108, while trimmer head 108 is spinning and because exit ports 208a and b at the top of trimmer head are more accessible than were the exit ports at the bottom of trimmer head 108.

Labels 210 are located on the exterior of top housing 204. Labels 210 indicate where to load trimmer lines 110a and b and/or where to remove trimmer lines 110a and b. Labels 210 may include arrows and text, such as “Load here” or “Pull from here to remove.”

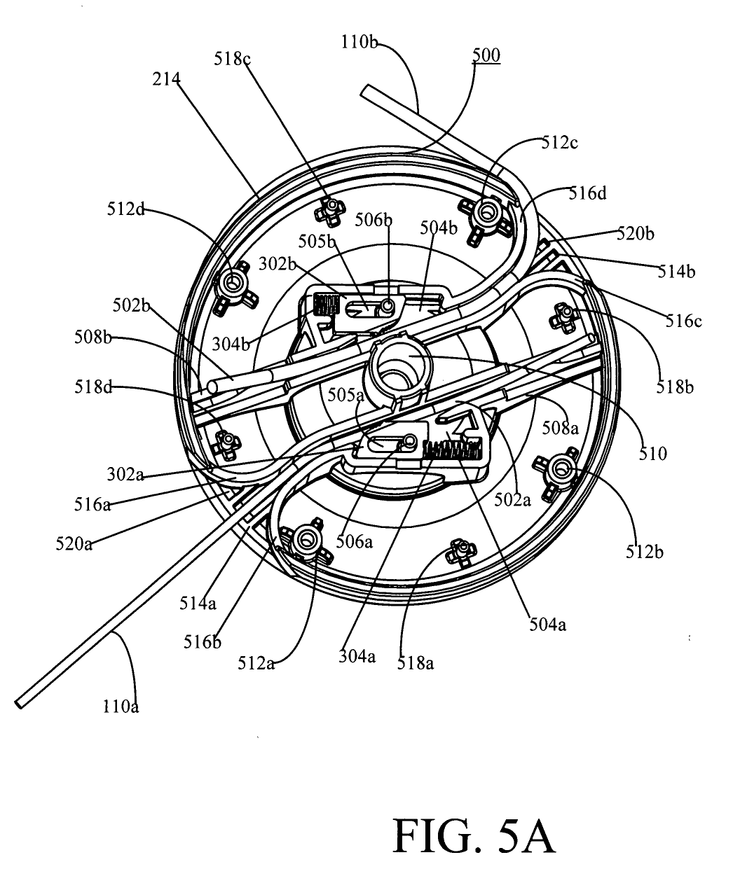

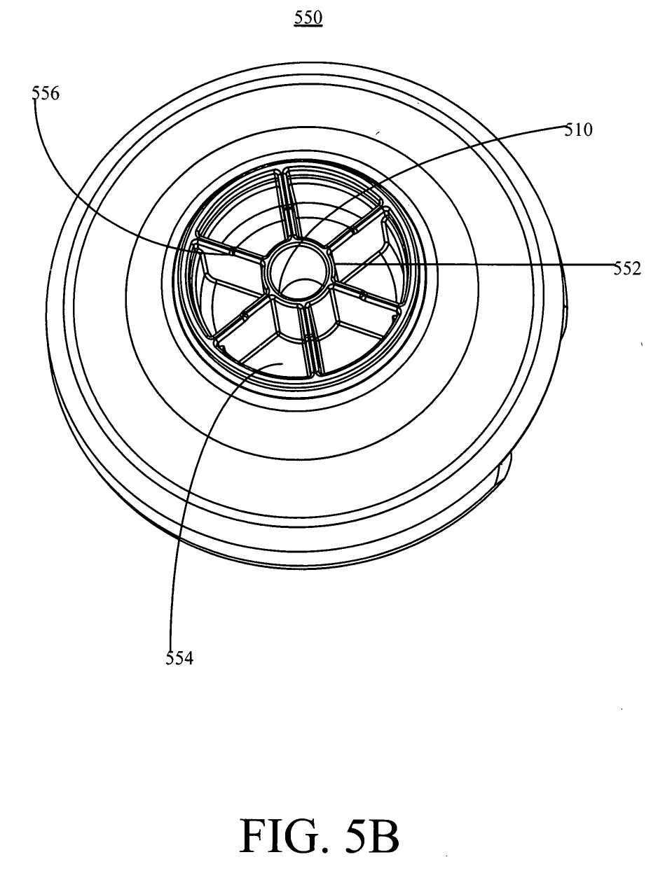

Entrance port 212 is for loading trimmer lines 110a and b. Entrance port 212 is at the periphery of the trimmer head 108. Another entrance port is located on the opposite side of trimmer head 108. The entrance ports are discussed further in conjunction with FIG. 5. One of trimmer lines 110a and b is pushed into entrance port 212 guided through trimmer head 108 and out of trimmer head 108 through one of exit ports 208a and b. The other of trimmer lines 110a and b is pushed into the other entrance port guided through trimmer head 108 and out of trimmer head 108 through the other of exit ports 208a and b. The user pushes trimmer lines 110a and b into trimmer lines 110a and b into the trimmer head until there is enough of trimmer lines 110a and b sticking out of exit ports 208a and b to grab trimmer lines 110a and b by hand.

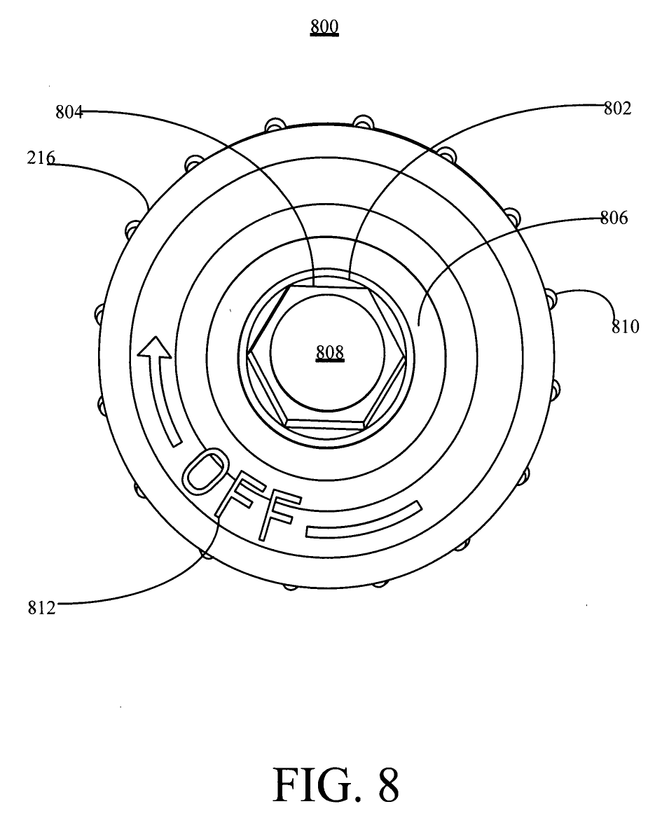

Bottom housing 214 protects trimmer head 108 from debris entering trimmer head 108 from the bottom. Bottom housing 214 and top housing 208 may together form entrance port 212. The interior of bottom housing 214 is discussed in conjunction with FIG. 5A. The exterior of bottom housing 214 is discussed in conjunction with FIG. 5B. Spacer 216 may be used as a knob to screw a bolt into driveshaft 202 to help hold top housing 208 to bottom housing 214. Spacer 216 is discussed further in conjunction with FIG. 8, below.

### Exploded View (FIG. 3)

FIG. 3 shows an embodiment of exploded view 300 of an embodiment of trimmer head 108. Exploded view 300 shows driveshaft 202, top housing 204, screws 206a-d, bottom housing 214, spacer 216. Driveshaft 202 has head 301a and shaft 301b. Exploded view 300 also shows clamps 302a and b, mechanical biases 304a and b, and bolt 306. In other embodiments, exploded view 300 may not have all of the elements listed and/or may have other elements instead of, or in addition to, those listed.

Driveshaft 202, top housing 204, screws 206a-d, bottom housing 214, and spacer 216 were discussed in conjunction with FIG. 2. Head 301a is noncircular and engages top housing 204. Shaft 301b of driveshaft 202 is a cylindrical body extending perpendicularly away from head 301a and extends through trimmer head 108 and connects to a bolt at the bottom of trimmer head 108. Clamps 302a and b hold trimmer lines 110a and b in place. Clamps 302a and b may have a jagged surface and may be referred to as cleats. Mechanical biases 304a and b push clamps 302a and b towards walls of passage ways within bottom housing 214 to help so that clamps 302a and b hold trimmer lines 110a and b in place. Clamps 302a and b are located near the center of trimmer head 108 to prevent trimmer head 108 from vibrating when only one of trimmer lines 110a and b breaks, as will be discussed in further in connection with FIG. 5A.

Bolt 306 is the bolt mentioned above that connects to the bottom of driveshaft 202. Specifically, bolt 306 extends through a hole in spacer 216, through a hole in bottom housing 216, and (for example) screws into shaft 301b of driveshaft 202, thereby holding spacer 216 to bottom housing 214, helping to hold trimmer head 108 together.

### Cross Section (FIG. 4)

FIG. 4 shows an embodiment of a cross section 400 of trimmer head 108. Cross section 400 shows driveshaft 202, top housing 208, bottom housing 214, spacer 216, and bolt 306. In other embodiments, cross section 400 may not have all of the elements listed and/or may have other elements instead of, or in addition to, those listed.

Driveshaft 202 top housing 208, bottom housing 214, and spacer 216 were discussed in conjunction with FIG. 2. Driveshaft 202 was also discussed in conjunction with FIG. 3. Head 301a and shaft 301b of driveshaft 202 and bolt 306 was discussed in FIG. 3. FIG. 4 shows another view illustrating how driveshaft 202 extends through top housing 208, though bottom housing 214, until spacer 216. FIG. 4 also shows how bolt 306 extends through spacer 216 and screws into the bottom (e.g., into an arbor) of shaft 301b of driveshaft 202.

### Bottom Housing (FIGS. 5A and 5B)

FIG. 5A shows an embodiment of the interior side 500 of bottom housing 214. Bottom housing 214 clamps 302a and b, mechanical biases 304a and b, channels 502a and b, chambers 504a and b, slots 505a and b, pins 506a and b, walls 508a and b, central hole 510, screw holes 512a-d, openings 514a and b, curved walls 516a-d, and alignment pins 518a-d. In other embodiments, interior side 500 of bottom housing 214 may not have all of the elements listed and/or may have other elements instead of, or in addition to, those listed.

Bottom housing 214 was also discussed in conjunction with FIG. 2. Clamps 302a and b and mechanical biases 304a and b were also discussed in FIG. 3.

Channels 502a and b guide trimmer lines 110a and b through trimmer head 108, via chambers 504a and b. Chambers 504a and b (e.g., cavities) are located along channels 502a and b at a point opposite the center of bottom housing 214. Pins 506a and b are located within chambers 504a and b respectively. In other words, clamps 302a and be are placed within chambers 504a and b such that pins 506a and b are located within slots 505a and b. In other words, clamps 302a and b have slots 505a and b within which pins 506a and b are located. Clamps 302a and b slide within chambers 504a and b on pins 506a and b. Slots 505a and b guide the movements of clamps 502a and b with the aid of the walls of chambers 504a and b and pins 506a and b.

The combination of slots 505a and b, clamps 302a and b, and the walls of chambers 504a and b guide the movement of clamps 504a and b to slide into channels 502a and b in a direction that is at an angle to the direction of channels 502a and b. Mechanical biases 304a and b push clamps 302a and b towards the trimmer lines 110a and b. More specifically, mechanical biases 304a and b pushes clamps 302a and b into the walls of channels 502a and b that are adjacent to clamps 302a and b, respectively. Chambers 504a and b, clamps 302a and b, mechanical biases 304a and b from a one-way gripping mechanism. In alternative embodiments, chambers 504a and b may be located within removable modules instead being formed within and being an integral part of bottom housing 214.

Trimmer line 110a passes between cleat 302a and the adjacent wall of channel 502a, and trimmer line 110b passes between cleat 302b and the adjacent wall of channel 502b. Jagged edges of clamps 302a and 302b are angled to allow trimmer lines 110a and b to pass by unhindered while moving in a traveling from the entrance ports towards the exit ports. However, as a result of mechanical biases 304a and b and the angling of jagged the edges of clamps 302a and 302b, clamps 302a and b dig into trimmer lines 110a when trimmer lines 110a and b are pulled in a direction going outwards through the entrance ports.

Walls 508a and b extend from channels 502a and b, and are angled upwards to guide trimmer lines 110a and b out of trimmer head 108 (FIG. 1) through exit ports 208a and b in top housing 204 (FIG. 2). Central hole 510 receives driveshaft 202 (FIGS. 2 and 3). Chambers 502a and b are located opposite central hole 510 at a location along channels 504a and b. Central hole 510 may have a collar, which may be received or mate with a corresponding well surrounding the central hole of top housing 214. Screw holes 512a-d receive screws 206a-d, which hold top housing 204 to bottom housing 214 (see also FIGS. 2 and 3).

By placing the gripping mechanisms (formed by slots 505a and b, clamps 302a and b, and the walls of chambers 504a and b) near the center of bottom housing 214, changes in the configuration of the gripping mechanism do not significantly affect the balance of trimmer head 108. Consequently, when one of trimmer lines 110a or 110b breaks, trimmer head 108 rotates without vibrations.

Openings 514a and b are the bottom portions of the entrance ports. For example opening 514a may be the bottom portion of entrance port 214. Openings 514a and b have curved wall 516a-d, which allow trimmer lines 110a and b to bend a considerable amount when trimmer lines 110a and b bang into something so that trimmer lines 110a and b are less likely to break while bending as a result of hitting something. The gradual curvature of curved walls 516a-d makes it less likely that trimmer lines 110a and b will be knocked into a sharply bent configuration, thereby extending the lifetime of trimmer lines 110a and b as compared to (for example) were there a sharp 90 bend in the walls of openings 514a and b at the entrance into trimmer head 108.

Alignment pins 518a-d are optional. Alignment pins 518a-d help align top housing 204 with bottom housing 214 while assembling trimmer head 108. Alignment pins 518a-d mate with alignment holes on top housing 204 (the alignment holes are also discussed in conjunction with FIG. 7).

Grids 520a and b are optional. Grids 520a and b strengthen openings 514a and b so that bottom housing 214 is less likely (than were grids 520a and b absent) to crack, as a result of the flailing of the trimmer lines 110a and b.

FIG. 5B shows exterior 550 of bottom housing 214 having central hole 510, neck 552, well 554, and fins 556. In other embodiments, exterior 550 of bottom housing 214 may not have all of the elements listed and/or may have other elements instead of, or in addition to, those listed.

Central hole 510 was discussed in conjunction with FIG. 5A, above. Neck 552 reinforces the opening forming central hole 510. Neck 552 is located within well 554, and within well 554 are fins 556, which strengthen neck 552. Neck 552, well 554, and fins 556 are optional, and central hole 510 could be reinforced in another manner.

### Top Housing (FIG. 6)

FIG. 6 shows an embodiment of exterior side 600 of top housing 204. Top housing 204 includes exit ports 208a and b, socket 602 with bottom surface 604, screw holes 606a-d, fins 608, and neck 610. In other embodiments, exterior side 600 of top housing 204 may not have all of the elements listed and/or may have other elements instead of, or in addition to, those listed.

Exit port 214 was discussed in conjunction with FIG. 2. Socket 602 has a noncircular shape that mates with the head of driveshaft 202, so that as driveshaft 202 rotates, driveshaft 202 causes top housing to rotate, and therefore causes trimmer head 108 to rotate. For example, socket 602 may have a hexagonal shape. Bottom surface 604 includes a hole that is smaller than the head of driveshaft 202, such that head 301a of driveshaft 202 pushes top housing 204 towards bottom housing 214, thereby holding trimmer head 108 together. Screw holes 606a-d receive screws 206a-d and align with screw holes 514a-d, such that screws 216a-d pass through screw holes 606a-d into screw holes 514a-d and thereby hold top housing 204 to bottom housing 214.

FIG. 7 shows an embodiment of interior side 700 of top housing 204 having central hole 701, wells 702a and b, chamber ceilings 704a and b, channels 706a and b, walls 709a and b, exit ports 708a and b, screw holes 710a-d, alignment holes 712a-d, grids 714a and b, and well 718. In other embodiments, interior side 700 of top housing 204 may not have all of the elements listed and/or may have other elements instead of, or in addition to, those listed.

Central hole 701 receives driveshaft 202. Wells 702a and b receive pins 506a and b, which helps align top housing 204 with bottom housing 214 during assembly and which also helps hold clamps 302a and b on pins 506a and b (FIG. 5A). Chamber ceilings 704a and b help keep clamps 302a and b (FIG. 3) within chambers 504a and b (FIG. 5A), respectively, and properly oriented so that clamps 302a and b slide smoothly. Chamber ceilings 704a and b are the edges of walls that extend down over clamps 302a and b. However, the walls could be replaced with a cover for chambers 504a and b and/or other structures and/or other mechanisms that hold clamps 302a and b within chambers 504a and b, for example. Channels 706a and b guide trimmer lines 110a and b to exit ports 708a and b. The top edges of walls 508a and b form floors for channels 706a and b, thereby guiding trimmer lines 110a and b. Exit ports 708a and b are embodiments of the interior sides of exit ports 214a and b (FIG. 2). Walls 709a and b are located above channels 502a and b (FIG. 5A) and, in an embodiment, are received within the top of channels 502a and b. Walls 709a and b keep trimmer lines 110a and b within channels 502a and b. Screw holes 710a-d receive screws 206a-d (FIG. 2) and align with screw holes 606a-d (FIG. 6). Screw holes 710a-d to screw holes 606a-d may have a collar such that screw holes 710a-d align with, and engage with, screw holes 606a-d.

Alignment holes 712a-d are optional and are not included if alignment pins 518a-d are not included. Alignment holes 712a-d mate with alignment holes 518a-d on bottom housing 214, and as a consequence, alignment holes 712a-d help align top housing 204 with bottom housing 214 while assembling trimmer head 108. Grids 714a and b are located above the entrance ports and reinforce the entrance port portion of top housing 204 so that trimmer lines 110a and b do not break top housing 204 during operation. Well 718 surrounds central hole 701, and receives, engages, and/or mates with the collar surrounding central hole 510, which helps align top housing 204 aligned with bottom housing 214 during assembly and help maintain top housing 204 in alignment with bottom housing 214 after assembly, during normal operations.

### Spacer (FIG. 8)

FIG. 8 shows an embodiment of bottom 800 of spacer 216. Spacer 216 includes grip 802, noncircular socket 804, and bottom surface 806 having hole 808. In other embodiments, bottom of spacer 216 may not have all of the elements listed and/or may have other elements instead of, or in addition to, those listed.

Grip 802 is a structure that aids in gripping spacer 216 so that spacer 216 may be turned easily. In an embodiment, grip 802 may include cylindrical bumps on the sides of spacer 216. In another embodiment, grip 802 may include depressions and/or bumps of other shapes to aid in gripping the sides of spacer 216. Noncircular socket 804 has a shape that mates with the head of bolt 306. Bottom surface 806 keeps bolt 306 from passing through spacer 216. Hole 808 is located in bottom surface 806 to allow the shaft of bolt 306 to pass through. The shaft of bolt 306 is inserted through hole 808, far enough so that the head of bolt 306 engages and mates with socket 804. The user then sticks the end of bolt 306 into the bottom of shaft 301b (FIG. 3). The user may then use spacer 216 to turn bolt 306 and screw bolt 306 into driveshaft 202. Using spacer 216 to turn spacer 216 allows the user to use spacer 216 instead of using a wrench. Consequently, the user does not need a wrench to assemble trimmer head 108.

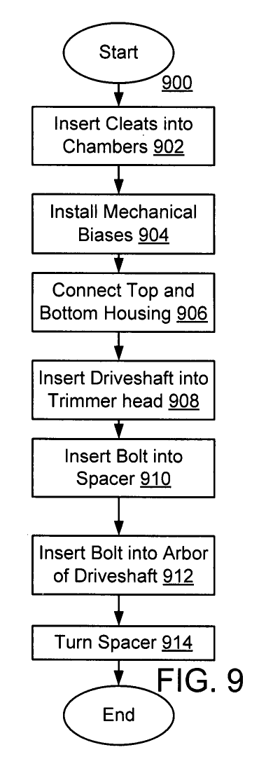

### Method of Assembling and Setting Up the Trimmer Head (FIG. 9)

FIG. 9 shows a flowchart of an embodiment of method 900 of assembling trimmer head 108. In step 901, the various components of the trimmer head 108 are manufactured. For example, driveshaft 202, top housing 204, screws 206a-d, bottom housing 216, spacer 216, bolt 306, clamps 302a and b, and mechanical biases 304a and b are manufactured. In step 902, clamps 302a and b are inserted into chambers 504a and b by placing pins 506a and b into slots 505a and b, respectively. In step 904 mechanical biases 506a and b are placed into chambers 504a and b in a manner such that mechanical biases 504a and b pushes against the walls of chambers 504a and b and clamps 302a and b, so as to push clamps 302a and b into channels 502a and b, respectively. In step 906, top housing 204 and bottom housing 214 are connected by, for example, inserting alignment pins 518a-d into alignment holes 712a-d, inserting pins 506a and b into wells 702a and b, inserting walls 709a and b into channels 502a and b, inserting channels 706a and b into walls 508a and b, aligning screw holes 710a-d with screw holes 512a-d. Next in step 908, screws 206a-d are inserted into screw holes 606a-d and then screwed into screw holes 512a-d. Also in step 908, shaft 301b of driveshaft 202 is inserted through central hole 701. Next in step 910, bolt 306 is inserted into hole 808 of spacer 216. Then, in step 912, bolt 306 is engaged with shaft 301b. Then, in step 914, spacer 216 is turned, which causes bolt 306 to turn and screw into shaft 202. In an embodiment, each of the steps of method 900 is a distinct step. In another embodiment, although depicted as distinct steps in FIG. 9, step 902-914 may not be distinct steps. In other embodiments, method 900 may not have all of the above steps and/or may have other steps in addition to or instead of those listed above. The steps of method 900 may be performed in another order. Subsets of the steps listed above as part of method 900 may be used to form their own method.

### Method of Loading Trimmer Line

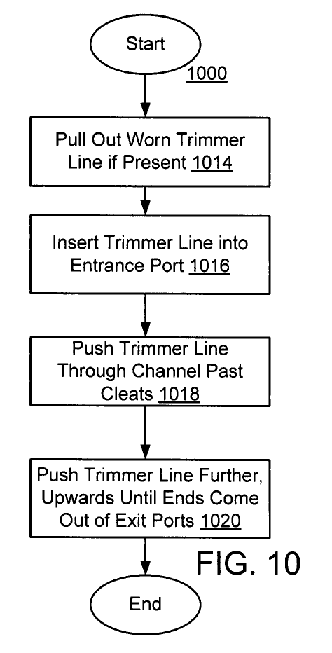

FIG. 10 shows a flowchart of an embodiment of method 1000 for loading trimmer line into trimmer head 108. In step 1014, if trimmer lines 110a and/or b are worn out, the worn out trimmer line is pulled out of trimmer head 108 by pulling the trimmer line out of exit ports 208a and b. In step 1016, trimmer lines 110a and b are inserted into the entrance ports. In step 1018, trimmer lines 110a and b are pushed through the channels 502a and b of trimmer head 108, pushing clamps 302a and b back against mechanical biases 304a and b. In step 1020, trimmer lines 110a and b are pushed further into trimmer head 108 guiding trimmer lines 110a and b upwards through exit ports 208a and b. In an embodiment, each of the steps of method 1000 is a distinct step. In another embodiment, although depicted as distinct steps in FIG. 10, step 1014-1020 may not be distinct steps. In other embodiments, method 1000 may not have all of the above steps and/or may have other steps in addition to or instead of those listed above. The steps of method 1000 may be performed in another order. Subsets of the steps listed above as part of method 1000 may be used to form their own method.

### Method of Using the Trimmer Head

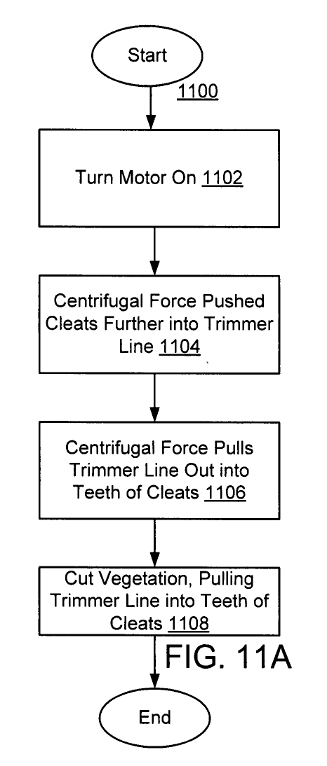

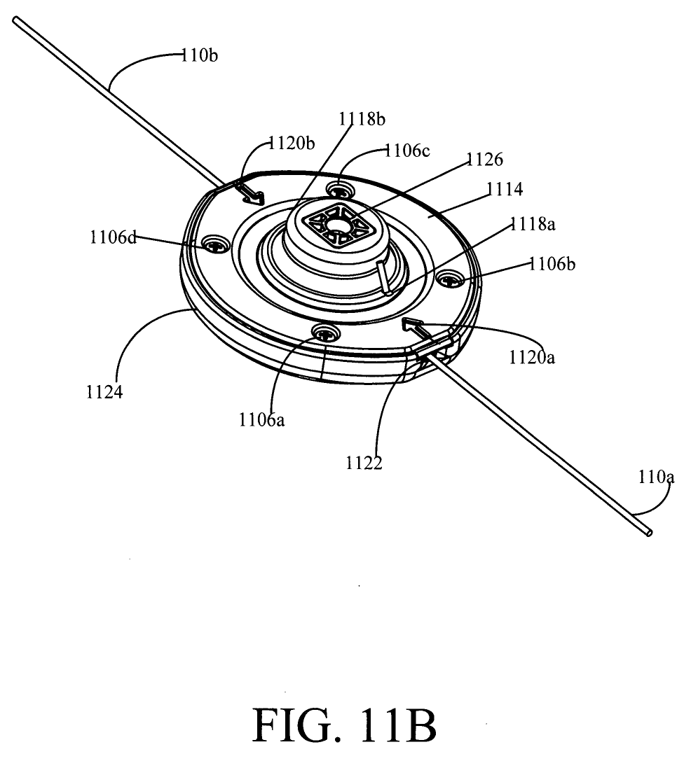

FIG. 11A shows a flowchart of an embodiment of method 1100 of using trimmer head 108. In step 1102, motor 104 is turned on causing trimmer head 108 to spin. In step 1104, the centrifugal force causes clamps 302a and b to press into trimmer line 1102. In step 1106, the centrifugal force pulls trimmer lines 110a and b in a direction that is outward through the entrance ports causing the teeth of clamps to dig into trimmer lines 110 a and b. In step 1108, trimmer head 108 cuts vegetation, and as the trimmer head 108 cuts, trimmer lines 110a and b are pulled upon pulling the trimmer line further into the teeth of clamps 302a and b. In an embodiment, each of the steps of method 1100 is a distinct step. In another embodiment, although depicted as distinct steps in FIG. 11, step 1102-1108 may not be distinct steps. In other embodiments, method 1100 may not have all of the above steps and/or may have other steps in addition to or instead of those listed above. The steps of method 1100 may be performed in another order. Subsets of the steps listed above as part of method 1100 may be used to form their own method.

### Further Discussion

Now that each of the figures. have been discussed in the numerical order of the figures, some of the aspects of various embodiments, are discussed below, while focusing on those topics (instead of focusing on explaining the figures) for the purpose of giving a better explanation of theses aspects.

Referring to FIGS. 5A and B, 6, and 7 of two main trimmer housing parts (top housing 204 and bottom housing 214) may be joined and fastened together with spacer 216. Spacer 216 may be replaceable and may be a combination of a knob and a ground spacer. Spacer 216 may function as a ground spacer by defining and/or regulating the cutting distance of the trimmer lines 110a and b from the ground surface. Spacer 216 may also function as a bolt fastener that is used to secure trimmer head 108 to driveshaft 202, without the need or use of a special wrench or tool, FIGS. 1, 3, 4, and 8. Trimmer head 108 is a fixed line trimmer head, which can be attached to a typical handheld motorized vegetation trimmer apparatus, such as vegetation trimmer 100. Trimmer head 108 may carry one or more radially outwardly projecting trimmer lines, such as trimmer lines 110a and b, which may cut the vegetation as trimmer head 108 rotates.

Referring to FIG. 1 there is shown one embodiment of trimmer head 108 that is used for cutting vegetation in conjunction with an internal combustion gas or electric powered handheld or wheeled vegetation trimmer, trimmer head 108 may include a rigid molded plastic first or “top” member, top housing 204, and a rigid molded plastic second or “bottom” member, bottom housing 214.

Upon installation of trimmer lines 110a and b, the gripping mechanisms (formed by clamps 302a and b), grip trimmer lines 110a and b (respectively). Top housing 204 and bottom housing 214, mechanical biases 304a and b, clamps 302a and b, and spacer 216 may be permanently or releasably fastened to one another. To facilitate maintenance or repair of trimmer head 108, top housing 204 and bottom housing 214 may be releasably connected by cooperating snaps, latches or, as illustrated, a plurality of alignment holes (such as alignment holes 712a-d, which are provided in each of top housing 204 and bottom housing 214) that receive a corresponding number of conventional bolts/screws, such as screws 206a-d.

In order to attach trimmer head 108 to the rotating driveshaft of vegetation trimmer 100, top housing 204 and bottom housing 214 are provided with aligned central bores (central hole 510 and central hole 701) of a diameter sufficient to receive driveshaft 202. Trimmer head 108 is not limited to the driveshaft configuration of FIG. 1—other driveshaft configurations may be used instead. The underside of bottom housing 214 may be molded so as to provide an integral central aperture, which is central hole 510 in FIGS. 5A and B. Central hole 510 receives a bolt or nut that is adapted to mate with the threads of the arbor of driveshaft 202, and releasably attach trimmer head 108 to driveshaft 202. Socket 602 (FIG. 6) prevents slippage of trimmer head 108 with respect to the driveshaft 202 in the event that the trimmer lines 110a and b of trimmer head 108 encounter solid objects or dense or otherwise difficult to cut grass, weeds or other vegetation (also see FIG. 2 in which driveshaft 202 is located in socket 606, which is unlabeled in FIG. 2).

Trimmer head 108 includes at least one of channel, such as channels 502a and b, for releasably receiving at least one trimmer line, such as trimmer lines 110a and b, in the form of a finite length (approximately 4-12″ long) of flexible monofilament plastic trimmer line, which may be made from nylon strand, for example. Mirror-imaged clamping members that are of a type that pivots or slides and has paws, and the clamping members are spring biased may be utilized in this fixed line trimmer head.

As seen in FIG. 5A for each of trimmer lines 110a and b, bottom housing 214 is molded so as to form one of chambers 504a and b (which may also be referred to as chambers) for receiving a means for releasably gripping trimmer lines 110a and b. Each of the chambers 504a and b, FIG. 5A is in communication with and disposed at an acute angle with respect to its respective one of channels 502a and b which is both non-linear and has multiple levels.

Each of chambers 504a and b (or chambers) may have a narrow aft portion and an enlarged fore portion. Depending on space considerations associated with a particular trimmer head design, the acute angle of one of chambers 504a and b may range from about 10 degrees to about 80 degrees with respect to the one of channels 502a and b. Pins 506a and b (FIG. 5A) may be molded into bottom housing 214 in the fore portions of chambers 504a and b. Pins 506a and b are oriented in an upstanding configuration, in which the pin 506a and b extend perpendicularly upwards from the bottom surface of chambers 504 and b.

As illustrated in FIG. 5A, according to one embodiment, each of the means for releasably gripping trimmer lines 110a and b includes a compression mechanical bias, such as mechanical biases 304a and b, which is shaped, and therefore adapted, to be received within aft portion of one of chambers 504a and b. Clamps 302a and b are configured to reciprocally slide within chambers 504a and b, respectively. In an embodiment, clamps 302a and b are generally “D-shaped,” rigid, and adapted to be received within the fore portions of chambers 504a and b. One end of mechanical biases 304a and b are seated against a rear wall of the aft portions of chambers 504a and b, whereas the opposite ends of mechanical biases 304a and b are seated against clamps 302a and b. FIGS. 4 and 5A reveal that in an embodiment bottom housing 214 is molded to include a lip which functions as a stop for clamps 302a and b when no trimmer lines 110a and b is present in channels 502a and b. Mechanical biases 304a and b may be selected to have a length such that mechanical biases 304a and b are at least slightly compressed when seated in the aft portions of chambers 504a and b between the rear walls of the aft portions and clamps 302a and b, even when trimmer lines 110a and b are not present in channels 502a and b, respectively.

Additionally, clamps 302a and b are provided with elongated slots 505a and b for receiving pins 506a and b. The cooperation of pins 506a and b, slots 505a and b, trimmer lines 110a and b, and clamps 302a and b assures that clamps 302a and b are restrained to a smooth, linear reciprocating motion at the aforementioned acute angle, this arrangement prevents disengagement of clamps 302a and b and mechanical biases 304a and b in the event that trimmer lines 110a and b should experience violent impacts arising from contact with solid objects and/or especially dense vegetation. In an embodiment, the faces of clamps 304a and b that are adapted to contact trimmer lines 110a and b are preferably provided with at least one sharp protrusion, such as one or more ribs or corrugations, knurling, or other textured surfacing for enhancing the gripping of trimmer lines 110a and b by clamps 302a and b.

In order to position a trimmer lines 110a and b in trimmer head 108, trimmer lines 110a and b are inserted into openings 514a and b (FIG. 5A), which form the entrance ports in the periphery of trimmer head 108, and passed along non-linear, multi-level passageways (formed by channels 504a and b, walls 508a and b, channels 706a and b, and walls 709a and b, see FIGS. 5A and 7) until the cutting member comes into contact with the faces of clamps 302a and b. Trimmer lines 110a and b are then further inserted at the periphery of the trimmer head by the user such that the free ends of the trimmer lines 110a and b project a desired distance from the “top side” of the trimmer head for unloading and reloading of fixed lengths of trimmer line. As trimmer lines 110a and b passes clamps 302a and b, trimmer lines 110a and b displace clamps 302a and b pushing clamps 302a and b into chambers 504a and b, respectively, along the aforementioned acute angle. The user then releases the trimmer lines 110a and b, and clamps 302a and b settle into gripping contact with trimmer lines 110a and b as a result of clamps 302a and b being pushed by mechanical biases 304a and b, respectively.

If clamps 302a and b have jagged edges and/or one or more teeth on the faces of clamps 302a and b, in an embodiment, the protrusions of jagged edge of clamps 302a and b may be oriented, at salient acute angles and may be as sharp as needed to penetrate the surface of trimmer lines 110a and b in the direction of insertion of trimmer lines 110a and b. The jagged edges and the angling of the jagged edges enhance the biting and holding effect of clamps 302a and b on trimmer lines 110a and b. This biting effect is further enhanced by drag and the centrifugal force when trimmer head 108 is rotatably driven by driveshaft 202 of the engine of vegetation trimmer 100, which (in an embodiment) is an internal combustion gas or electric powered apparatus. While trimmer head 108 rotates between 8-12,000 rpms, trimmer lines 110a and b tend to make constant contact with vegetation and hard objects, which causes a combination of forces (e.g., a combination of pulling and frictional forces) to be applied to the extended portions of trimmer lines 110a and b. The pulling and frictional forces are the most dominate forces that make these mechanical one way gripping mechanism perform effectively under the extreme application and environment of vegetation trimmers.

In order to replace damaged or worn trimmer lines, the user stops (e.g., shuts off) vegetation trimmer 100 and grasps the ends of trimmer lines 110a and b that extend out of exit ports 208a and b of top housing 204 (FIGS. 2 and 6). Trimmer lines 110a and b may be directed at angle of between 45 degrees and 90 degrees at the point at which trimmer lines 110a and b exit trimmer head 108, via exit ports 208a and b. Angling trimmer lines 110a and b at the top of trimmer head 108 and/or at an angle between 45 and 90 as trimmer lines 110 a and b facilitates grasping the end of trimmer lines 110a and b for “unloading.” easier and more accessible for the end user than were the trimmer line ext from the bottom side of the trimmer head.

The top unloading feature and/or the placement of the gripping mechanisms at the center of the trimmer head 108 may be used in combination with other gripping mechanisms, such as a spring biased pivoting cam or another gripping mechanism.

Bottom housing 214 is molded so as to form one of chambers 302a and b for receiving means for releasably gripping trimmer lines 110a and b. Each of the chambers 504a and b is in communication with and disposed with respect to its respective combination of entrance port, passageway, and exit port for one of trimmer lines 110a and b to pass through.

One pair of means for releasably gripping trimmer lines 110a and b include torsion or extension springs and pivotal cam cleat members adapted to be received within fore portions of chambers 302a and b. One end of mechanical biases 304a and b are seated against adjacent walls and the opposite ends of mechanical biases 304a and b are seated in a notch/slot formed in pivotal cam cleat members. Mechanical biases 304a and b may be mounted to the underside of pivotal cam cleat members and aligned with corresponding apertures provided in top housing 204 and bottom housing 214 to include openings located in top housing 204 to receive screws.

In embodiments described herein, the trimmer line gripping means of the present invention is essentially constructed and employs a pair of gripping clamps that are oriented in a mirror-imaged arrangement with respect to each other that are mounted near the center axis identically the same distance apart from each other for clamping each single fixed cut length strand of line to be held by the trimmer head. It will be appreciated, therefore, that trimmer head 108 provides a simple, reliable and comparatively inexpensive construction that may be readily adapted to virtually any rotatable trimmer head design.

### Perspective View of Another Embodiment

FIG. 11B shows another embodiment of trimmer head 108. Trimmer head 108 includes top housing 1114 having screws 1116a-d, exit port 1118a (exit port 1118b is hidden), and labels 1120a and b. Trimmer head 108 also includes, entrance port 1122, bottom housing 1124, adaptor 1126. In other embodiments, the embodiment of FIG. 11 of trimmer head 108 may not have all of the elements listed and/or may have other elements instead of, or in addition to, those listed.

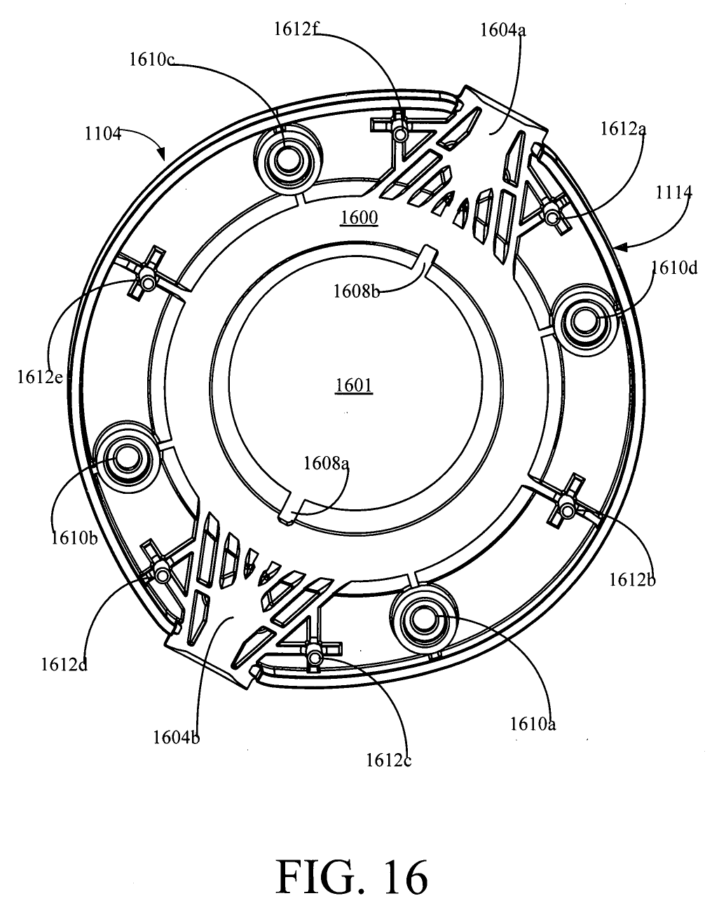

Top housing 1114 covers trimmer head 108 preventing debris from entering trimmer head 108 via the top. The interior of top housing 1114 is discussed further in conjunction with FIG. 16. Screws 1116a-d help hold top housing 1114 to the bottom housing of trimmer head 108, so that top housing 1114 and the bottom housing rotate together.

Exit ports 1118a and b may be used for removing trimmer lines 110a and b from trimmer head 108 after trimmer lines 110a and b are worn. Exit ports 1118a and b are placed in the top of top housing 1114, instead of in the bottom of trimmer head 108 (in contrast to prior art trimmer heads), because entrance ports at the bottom of trimmer heads tend to get clogged with debris that is sucked up by the vacuum created under trimmer head 108, while trimmer head 108 is spinning, and because exit ports 1118a and b at the top of trimmer head 108 are more accessible than were the exit ports at the bottom of trimmer head 108.

Labels 1120a and b are located on the exterior of top housing 1114. Labels 1120a and b indicate where to load trimmer lines 110a and b and/or where to remove trimmer lines 110a and b. Although in the embodiment illustrated in FIG. 11B labels 1120a and b includes just arrows, labels 1120a and b may include text, such as “Load here” or “Pull from here to remove” in addition to or instead of the arrows.

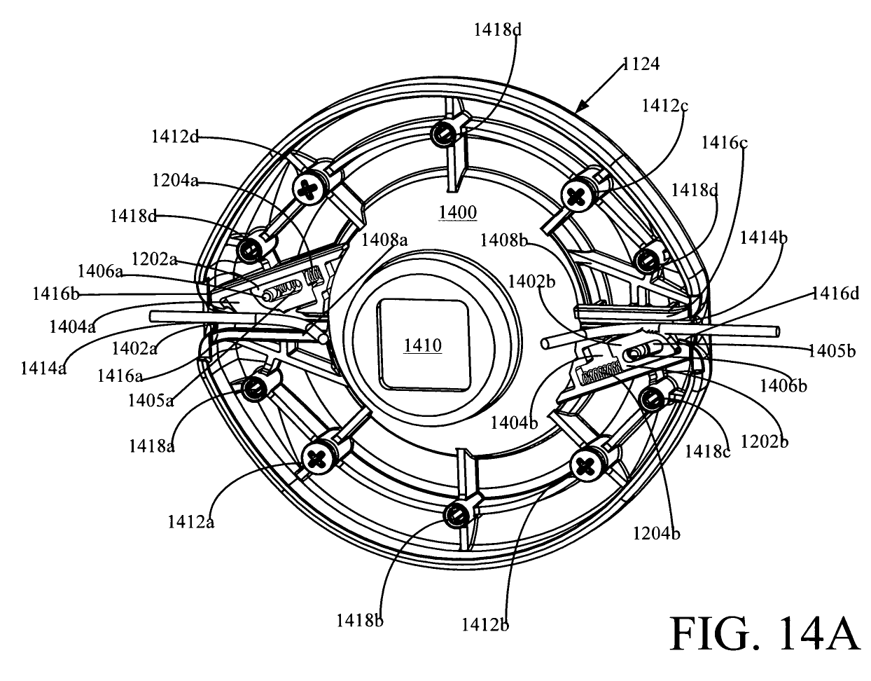

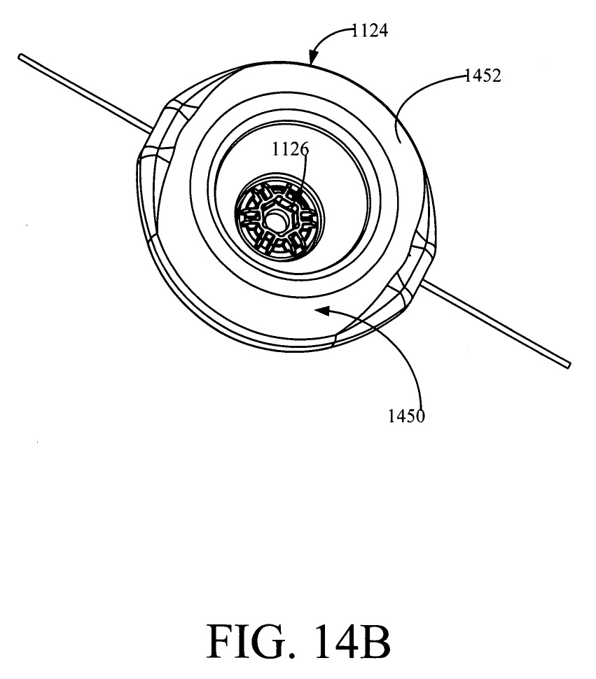

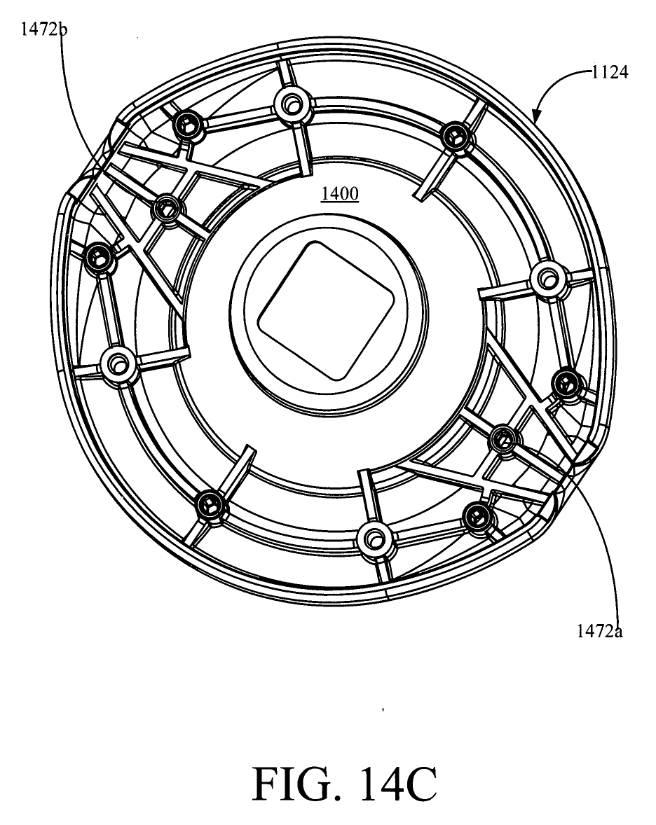

Entrance port 1122 is for loading trimmer lines 110a and b. Entrance port 1122 is at the periphery of the trimmer head 108. Another entrance port (not shown in FIG. 11) is located on the opposite side of trimmer head 108. The entrance ports are discussed further in conjunction with FIG. 14. One of trimmer lines 110a and b is pushed into entrance port 1122 guided through trimmer head 108 and out of trimmer head 108 through one of exit ports 1118a and b. The other of trimmer lines 110a and b is pushed into the other entrance port guided through trimmer head 108 and out of trimmer head 108 through the other of exit ports 1118a and b. The user pushes trimmer lines 110a and b into the trimmer head 108 until there is enough of trimmer lines 110a and b stick out of the exit ports 1118a and b to grab trimmer lines 110a and b by hand.

Bottom housing 1124 protects trimmer head 108 from debris entering trimmer head 108 from the bottom. In an embodiment bottom housing 1124 has not opening at the bottom of trimmer head 108 except for a hole that connects trimmer head 108 to a driveshaft. Bottom housing 1124 and top housing 1118 may together form entrance port 1122. The interior of bottom housing 1124 is discussed in conjunction with FIG. 14A. The exterior of bottom housing 1124 is discussed in conjunction with FIG. 14B. Adaptor 1126 engages and supports the bottom of bottom housing 1124. The driveshaft is inserted into the hole in adaptor 1126, and a nut holds adaptor 1126 to the driveshaft and thereby holds trimmer head 108 to the driveshaft.

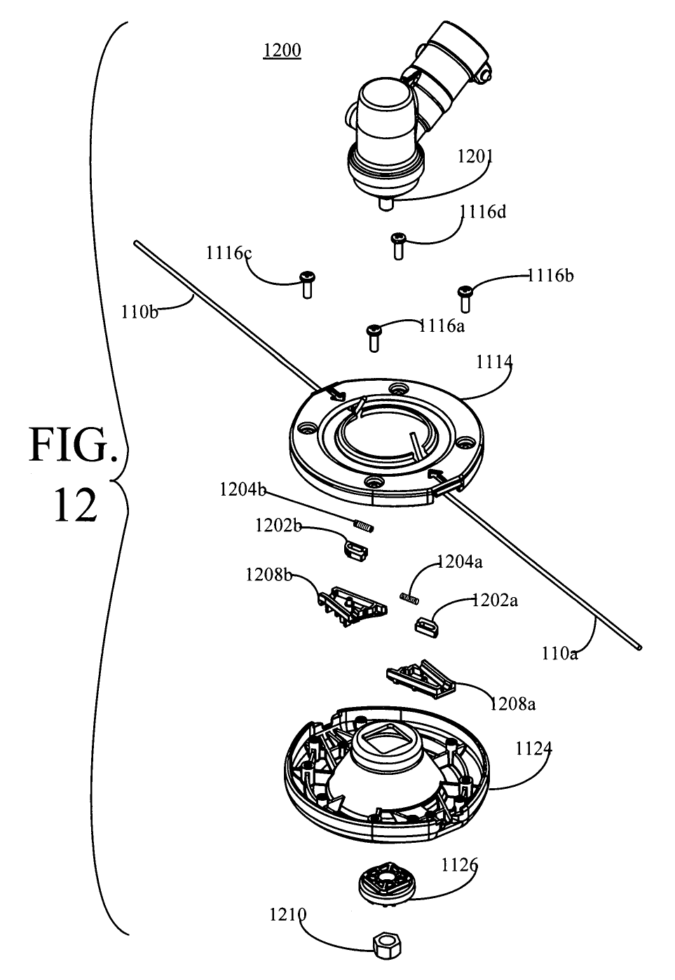

### Exploded View of Another Embodiment (FIG. 12)

FIG. 12 shows an exploded view 1200 of an embodiment of trimmer head 108. Exploded view 1200 shows top housing 1114, screws 1116a-d, bottom housing 1124, and adaptor 1126. Exploded view 1200 also shows drive shaft 1201, clamps 1202a and b, mechanical biases 1204a and b, modules 1208a and b, and fastener 1210. In other embodiments, exploded view 1200 may not have all of the elements listed and/or may have other elements instead of, or in addition to, those listed.

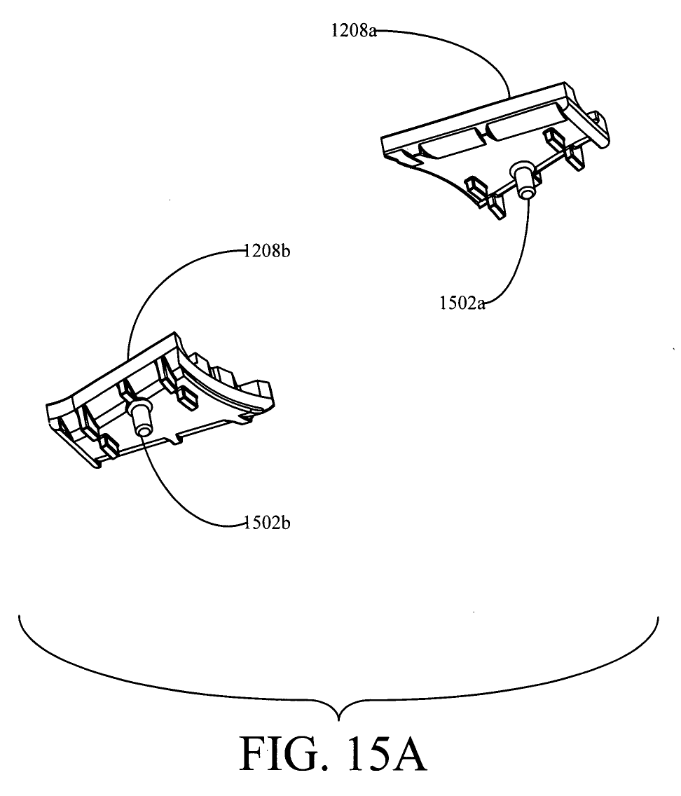

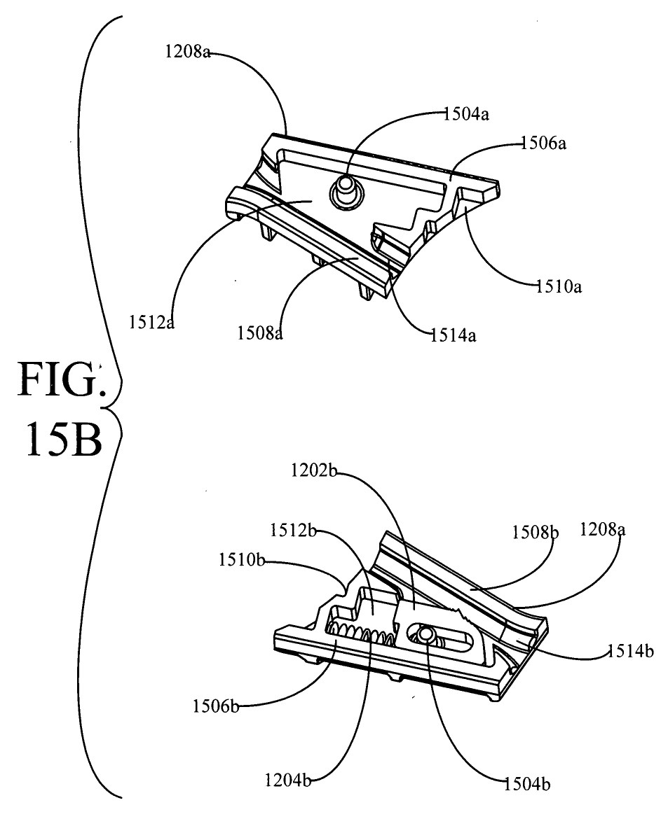

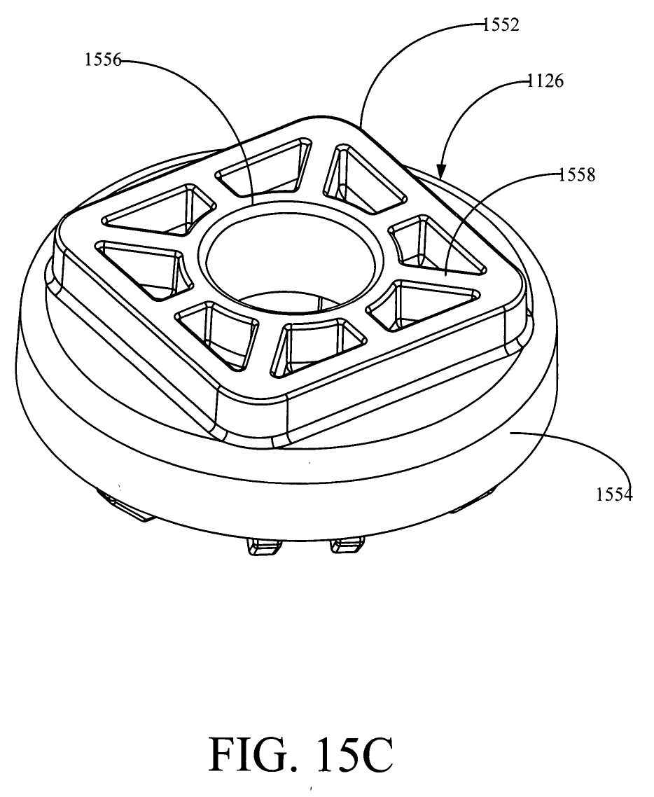

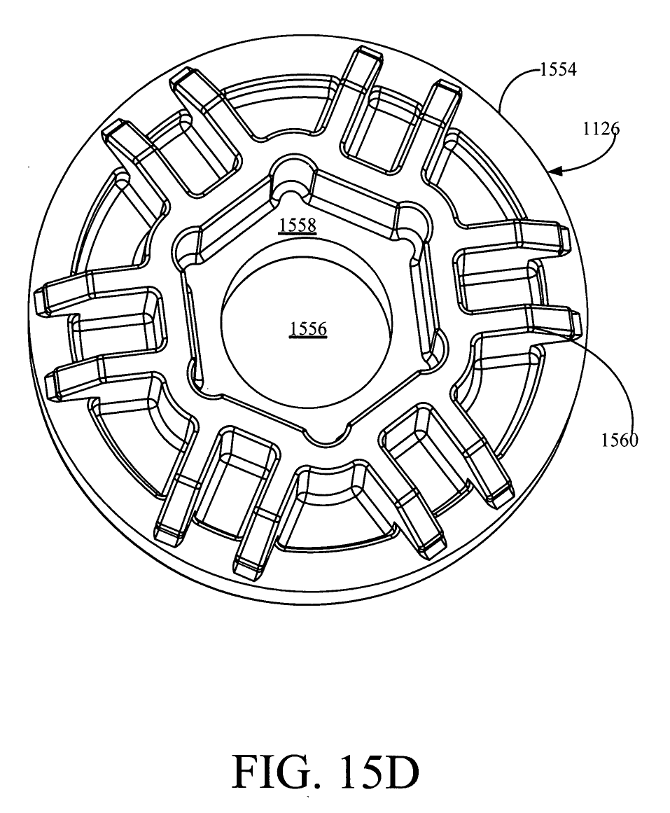

Top housing 1114, screws 1116a-d, bottom housing 1124, and adaptor 1126 were discussed in conjunction with FIG. 11. Driveshaft 1201 causes trimmer head 108 to spin. The trimmer motor causes driveshaft 1201 to spin, which in turn causes trimmer had 108 to spin. Clamps 1202a and b hold trimmer lines 110a and b in place while cutting. Clamps 1202a and b may have a jagged surface and may be referred to as cleats. Mechanical biases 1204a and b push clamps 1202a and b towards walls of passage ways within modules within bottom housing 1124 so that clamps 1202a and b hold trimmer lines 110a and b in place. Modules 1208a and b are removable and hold clamps 1202a and b and mechanical biases 1204a and b. In an embodiment, mechanical biases 1204a and b push clamps 1202a and b into walls of modules 1208a and b to hold trimmer lines 110a and b in place. Clamps 1202a and b are part of removable modules 1208a and b, as will be discussed in further in connection with FIG. 15D.

Fastener 1210 connects to the bottom of driveshaft 1201. Fastener 1210 may be a nut having a noncircular outer perimeter. Specifically, driveshaft 1201 extends through a hole in adaptor 1126, through a hole in bottom housing 1124, and (for example) screws into fastener 1210, thereby holding adaptor 1126 to bottom housing 1124 and to vegetation trimmer 100, and also helps to hold trimmer head 108 together.

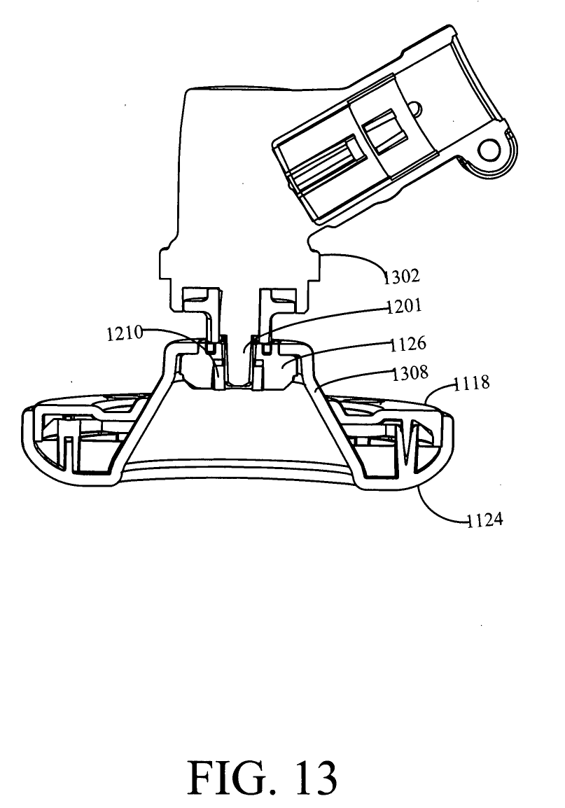

### Cross Section of Another Embodiment (FIG. 13)

FIG. 13 shows an embodiment of cross section 1300 of trimmer head 108. Cross section 1300 shows top housing 1118, bottom housing 1124, adaptor 1126, driveshaft 1201, fastener 1210, and a portion-of-the-vegetation-trimmer 1302. Bottom housing 1124 includes conical portion 1308. In other embodiments, cross section 1300 may not have all of the elements listed and/or may have other elements instead of, or in addition to, those listed.

Top housing 1118, bottom housing 1124, and adaptor 1126 were discussed in conjunction with FIG. 11. Driveshaft 1201 and fastener 1210 were discussed in FIG. 12. FIG. 13 shows another view illustrating how driveshaft 1201 extends through conical portion 1308 of bottom housing 1124. Conical section 1308 protrudes through a hole in the center of top housing 1118. FIG. 13 also shows how driveshaft 1201 is attached to a portion-of-vegetation-trimmer 1302, extends through adaptor 1126, and screws into fastener 1210. In an embodiment, driveshaft 1201 is threaded such that when driveshaft 1201 turns, fastener 1210 is rotated (without being unscrewed), which in turn engages and therefore rotates adaptor 1126, which in turn engages and therefore rotates bottom housing 1124 and therefore rotates trimmer head 108. In other embodiments another mechanism is used for connecting trimmer head 108 to the rest of vegetation trimmer 100 and for translating the spinning of drive shaft 1201 to the spinning of trimmer head 108. In an alternative embodiment, top housing 1118 may also have a conical portion that covers (e.g., and mates with) conical portion 1308, or top housing 1124 may have a conical section that completes and forms a top section of a cone, where the conical section of bottom housing 1124 forms the bottom section of the same cone.

### Bottom Housing of Another Embodiment (FIGS. 14A and 14B)

FIG. 14A shows an embodiment interior side 1400 of bottom housing 1124. Bottom housing 1124 clamps 1202a and b, mechanical biases 1204a and b, channels 1402a and b, chambers 1404a and b, slots 1405a and b, pins 1406a and b, walls 1408a and b, central hole 1410, screw holes 1412a-d, openings 1414a and b, curved walls 1416a-d, and alignment holes 1418a-f. In other embodiments, interior side 1400 of bottom housing 1124 may not have all of the elements listed and/or may have other elements instead of, or in addition to, those listed.

Bottom housing 1124 was also discussed in conjunction with FIG. 11. Clamps 1202a and b and mechanical biases 1204a and b were also discussed in conjunction with FIG. 12.

Channels 1402a and b guide trimmer lines 110a and b through trimmer head 108, via chambers 1404a and b. Chambers 1404a and b (e.g., cavities) are located along channels 1402a and b at opposite edges of bottom housing 1124. Pins 1406a and b are located within chambers 1404a and b, respectively. In an embodiment, clamps 1202a and b are placed within chambers 1404a and b such that pins 1406a and b are located within slots 1405a and b. In other words, clamps 1202a and b have slots 1405a and b within which pins 1406a and b are located. Clamps 1202a and b slide within chambers 1404a and b on pins 1406a and b. Slots 1405a and b guide the movements of clamps 1402a and b with the aid of the walls of chambers 1404a and b and pins 1406a and b, respectively.

The combination of slots 1405a and b, clamps 1202a and b, and the walls of chambers 1404a and b guide the movement of clamps 1404a and b to slide into channels 1402a and b in a direction that is at an angle to the direction of channels 1402a and b. Mechanical biases 1204a and b push clamps 1202a and b towards the trimmer lines 110a and b. More specifically, mechanical biases 1204a and b pushes clamps 1202a and b into the walls of channels 1402a and b that are adjacent to clamps 1202a and b, respectively. Chambers 1404a and b, clamps 1202a and b, mechanical biases 1204a and b from a one-way gripping mechanism. In an embodiment chambers 1404a and b may be formed by modules 1208a and b, respectively, which are removable from bottom housing 1124. In another embodiment, chambers 1404a and b integral parts of (e.g., formed by the molding process of) bottom housing 1124.

Trimmer line 110a passes between clamp 1202a and the adjacent wall of channel 1402a, and trimmer line 110b passes between clamp 1202b and the adjacent wall of channel 1402b. Jagged edges of clamps 1202a and 1202b are angled to allow trimmer lines 110a and b to pass by unhindered (or essentially unhindered—that is trimmer lines 110a and b pass by without damaging trimmer lines 110a and b and while pushing against the force of mechanical biases 1204a and b to move clamps 1202a and b out of the way, respectively) while moving in a traveling from the entrance ports towards the exit ports. However, as a result of mechanical biases 1204a and b and the angling of jagged the edges of clamps 1202a and 1202b, clamps 1202a and b dig into trimmer lines 110a when trimmer lines 110a and b are pulled in a direction going outwards through the entrance ports, hindering the removal of trimmer line 110a and b when trimmer lines 110a and b are pulled in an outward direction from the entrance ports.

Walls 1408a and b form one side of channels 1402a and b, and guide trimmer lines 110a and b out of trimmer head 108 (FIG. 1) through exit ports 1118a and b in top housing 1114 (FIG. 11). Central hole 1410 receives adaptor 1126 for engaging driveshaft 1201 (FIGS. 11 and 12). Chambers 1402a and b extend away from central hole 1410. Chambers 1402a and b are located at a location along channels 1404a and b. Central hole 1410 may be shaped to mate with a portion of adaptor 1126, corresponding to a well or depression surrounding central hole 1410 of bottom housing 1124. Screw holes 1412a-d receive screws 1116a-d, which hold top housing 1114 to bottom housing 1124 (see also FIGS. 11 and 12). Although in FIG. 14A screws 1116a-d are located within screw holes 1412a-d, in order to assemble the trimmer head screws 1116a-d would be screwed in after attaching top housing 1118 to bottom housing 1124.

Openings 1414a and b are the bottom portions of the entrance ports. For example opening 1414a may be the bottom portion of entrance port 1122. Openings 1414a and b have curved wall 1416a-d, which allow trimmer lines 110a and b to bend a considerable amount when trimmer lines 110a and b bang into something so that trimmer lines 110a and b are less likely to break while bending as a result of hitting something. The gradual curvature of curved walls 1416a-d makes it less likely that trimmer lines 110a and b will be knocked into a sharply bent configuration, thereby extending the lifetime of trimmer lines 110a and b as compared to (for example) were there a sharp 90 bend in the walls of openings 1414a and b at the entrance into trimmer head 108.

Alignment holes 1418a-f are optional. Alignment holes 1418a-f help align top housing 204 with bottom housing 1124 while assembling trimmer head 108. Alignment holes 1418a-d mate with alignment pins on top housing 1114 (the alignment pins are also discussed in conjunction with FIG. 16). In an alternative embodiment, the alignment pins are replaced with and alignment holes, and alignment holes 1418a-f are replaced with alignment pins.

FIG. 14B shows an embodiment of exterior side 1450 of bottom housing 1124 having adaptor 1126 and neck 1452. In other embodiments, exterior side 1450 of bottom housing 1124 may not have all of the elements listed and/or may have other elements instead of, or in addition to, those listed.

Exterior side 1450 has no holes other than central hole 1410, which is closed off (and hidden from view) by adaptor 1126, so that debris cannot enter through the bottom of trimmer head 108. Central hole 1410 is shown in FIG. 14A and was discussed in conjunction with FIG. 14A, above.

FIG. 14C shows an embodiment of interior side 1400 of bottom housing 1124 without modules 1208a and b. In addition to the features shown in FIG. 14A, interior side 1400 may also include alignment holes 1472a and b. In other embodiments, interior side 1400 of bottom housing 1124 may not have all of the elements listed and/or may have other elements instead of, or in addition to, those listed.

Alignment holes 1472a and b engage pegs on modules 1208a and b, and align modules 1208a and b in a desired position. The region surrounding alignment holes 1472a and b is shaped to receive modules 1208a and b in a fixed position, such that when modules 1208a and b are fixed to alignment holes 1472a and b modules 1208a and b are held in fixed positions.

### Modules of Another Embodiment (FIG. 15)

FIG. 15A shows an embodiment of the bottom sides of modules 1208a and b. Modules 1208a and b have pegs 1502a and b. In other embodiments, modules 1208a and b may not have all of the elements listed and/or may have other elements instead of, or in addition to, those listed.

The modules 1208a and b are from two different embodiments illustrated in FIG. 15A. The embodiment of module 1208a has another module that is a mirror image of module 1208a, and the embodiment of module 1208b has another module that is a mirror image of module 1208b. Pegs 1502a and b mate with alignment holes 1472a and b, respectively. As a result of pegs 1502a and b and the shape of modules 1208a and b modules 1208a and be fit snugly into interior side 1400. In an embodiment pegs 1502a and b are replaced with holes, and alignment holes 1472a and b are replaced with pegs. In another embodiment, modules 1208a and b are held in place by another mechanism.

FIG. 15B shows an embodiment of the top sides of modules 1208a and 1208b, which may include clamp 1202a, mechanical bias 1204a, pins 1504a and b, walls 1506 a and b, 1508 a and b, and 1510 a and b, floor 1512a and b, and track 1514a and b. In other embodiments, the top sides of modules 1208a and b may not have all of the elements listed and/or may have other elements instead of, or in addition to, those listed.

Clamp 1202a and mechanical bias 1204a were discussed in conjunction with FIG. 12. Clamp 1202b and mechanical bias 1204b are not shown so that the interior of module 1208b may be better seen. Pins 1504a and b engage slots within clamps 1202a and b, so that clamps 1202a and b may slide within the cavities formed in the interior of modules 1208a and b. Walls 1504a and b, 1508a and b, and 1510a and b, and floor 1512a and b for the cavities (which may be embodiments of chambers 1404a and b, respectively) within which clamps 1202a and b slide. Walls 1506a and b guide clamps 1202a and b so that clamps 1202a and b slide along a straight line parallel to walls 1506a and b. Walls 1506a and b also include a hooked portion at the end furthest from the location where mechanical biases 1204a and b are placed. The hooked portion prevents clamps 1202a and b from being pushed out of modules 1208a and b by mechanical biases 1204a and b. Walls 1508a and b form one side of tracks through which trimmer lines 110a and b pass. In an embodiment, walls 1510a and b have a staircase shape so that the combination of walls 1510a and b, 1506a and b and floors 1512a and b form a recess within which mechanical biases 1204a and b are held and located. Tracks 1514a and b are formed by floor 1512a and b, walls 1508a and b, the hook portions of walls 1506a and b and the end portions of wall 1510a and b that are closest to walls 1508a and b. Tracks 1514a and b receive trimmer lines 110a and b, which are pressed against walls 1508a and b by clamps 1202a and b as a result of the pushing of mechanical biases 1204a and b. In an embodiment, when trimmer lines 110a and b are not present, mechanical biases 1204a and b may push clamps 1202a and b into the hooked ends of walls 1504a and b and/or into walls 1508a and b. Tracks 1514a and b may be the portion of channels 1402a and b that passes through modules 1208a and b. In another embodiment, tracks 1514a and b have ramps guiding trimmer lines 110a and b upwards into exit ports 1118a and b (FIG. 11B). The ramps allow trimmer lines 110a and b to bend more gradually than when guided by the slope of conical section 1308 (FIG. 13). In an embodiment, pins 1504a and b and walls 1508a and b may be embodiments of pins 1406a and b, and walls 1408a and b, respectively.

### Adaptor (FIGS. 15C and D)

FIG. 15C shows an embodiment of a top side of adaptor 1126. Adaptor 1126 may include noncircular collar 1552, base 1554, hole 1556, and ribs 1558. In other embodiments, adaptor 1126 may not have all of the elements listed and/or may have other elements instead of, or in addition to, those listed.

Noncircular collar 1552 mates with a hole or depression in the trimmer head housing (e.g., bottom housing 1124), so that when adaptor 1126 is turned, trimmer head 108 also turns. Base 1554 supports trimmer head 108 by supporting bottom housing 114. Hole 1556 receives bolt 1304. Ribs 1558 are optional and provide structural support to adaptor 1126.

FIG. 15D shows an embodiment of the bottom side of adaptor 1126, which may include base 1554 of adaptor 1126. Adaptor 1126 may include base 1554, hole 1556, noncircular socket 1558, and ribs 1560. Base 1554 and hole 1556 were discussed in conjunction with FIG. 15C. In other embodiments, bottom side of adaptor 1126 may not have all of the elements listed and/or may have other elements instead of, or in addition to, those listed.

FIG. 15D shows the other side of base 1554 and hole 1556. Noncircular socket mates with a fastener 1210 or with a bolt head at the end of bolt 1304. When bolt 1304 is turned by the trimmer motor, bolt 1304 turns fastener 1210, which (as a result of mating with noncircular socket 1558) causes adaptor 1126 to turn, which in turn causes bottom housing 1124 to turn, which in turn causes trimmer head 108 to turn. An upward slope is placed at the end of modules 1208a and b from which trimmer lines 110a and b exit. The slopes directs trimmer lines 110a and b upwards and out of trimmer head 108 through exit ports

### Top Housing of Another Embodiment (FIG. 16)

FIG. 16 shows interior side 1600 of top housing 1114 having central hole 1601, chamber ceilings 1604a and b, exit ports 1608a and b, screw holes 1610a-d, and alignment pegs 1612a-f. In other embodiments, interior side 1600 of top housing 1114 may not have all of the elements listed and/or may have other elements instead of, or in addition to, those listed.

Central hole 1601 receives insert 1102. Pegs 1612a-f engage alignment holes 1418a-f, which helps align top housing 1114 with bottom housing 1124 during assembly. Chamber ceilings 1604a and b may help keep clamps 1202a and b (FIG. 12) within chambers 1404a and b (FIG. 14A), respectively, and properly oriented so that clamps 1202a and b slide smoothly. However, chamber ceilings 1604a and b could be replaced with a cover for chambers 1404a and b and/or other structures and/or other mechanisms that hold clamps 1202a and b within chambers 1404a and b, for example. Exit ports 1608a and b are embodiments of the interior sides of exit ports 1118a and b (FIG. 11). Screw holes 1610a-d receive screws 1116a-d (FIG. 11) and align with screw holes 1412a-d (FIG. 15). Screw holes 1610a-d to screw holes 1412a-d may have a collar such that screw holes 1610a-d align with, and engage with, screw holes 1412a-d.

Alignment holes 1612a-d are optional and are not included if alignment holes 1418a-d are not included. Alignment holes 1612a-d mate with alignment holes 1418a-d on bottom housing 1124, and as a consequence, alignment holes 1612a-d help align top housing 1114 with bottom housing 1124 while assembling trimmer head 108.

### Extensions and Alternatives

There are many variations to trimmer head 108 that do not depart from the inventions. The following are examples of some of those variations. However, the following is not an exhaustive list of all of the variations of trimmer head 108 that are within the scope of the invention.

Instead of forming the entrance ports at the place where top housing 204 and bottom housing 214 meet, top housing 204 or bottom housing 214 may be extended and constructed to include the entrance ports 208a and b. Instead of mounting the one-way gripping mechanism within bottom housing 214, the one way gripping mechanism could be mounted within top housing 204 (FIG. 2). Central hole 510 could be reinforced with a metal rim, and/or bottom housing 214 could include a metal frame supporting the metal reinforcing of central hole 510 in addition to or instead of neck 552, well 554, and/or fins 556 (FIG. 5B). Instead of alignment pins 518a-d (FIG. 5A) being located on bottom housing 214 and alignment holes 712a-d (FIG. 7) being located on top housing 204, any combination of or all of pins 518a-d being located on top housing 204 and the corresponding one of holes 712a-d may be located on bottom housing 214. Instead of pins 506a and b (FIG. 5A) being located on bottom housing 214, and holes 702a and b being located on top housing 204, pins 506a and b may be located on top housing 204 and holes 702a and b may be located on bottom housing 214 under clamps 302a and b (FIG. 3) flush with the floor of chambers 502a and b (FIG. 5A). In an embodiment, instead of clamps 302a and b having slots 506a and b and one of top housing 204 or bottom housing 214 having pins 505a and b, clamps 302a and b may have pins 505a and b and one of top housing 204 and bottom housing 214 may have slots 506a and b (FIG. 5A). Although four screws 206a-d are illustrated in FIG. 2 for example, screws 206a-d are optional, if alignment pins are present, to keep top housing 204 aligned with bottom housing 214, so that bottom housing 214 spins with top housing 204. Similarly, instead of four screws, there may be any number of screws (e.g., there may be 1, 2, 3, 4, 5, 6, 7, or 8 screws). As another alternative, spacer 216 may screw onto bottom housing 216, and instead of driveshaft 202 having a cylindrical shaft 301b (FIG. 301b), a large nut having the same size and shape as driveshaft head 301a may replace driveshaft 202 and there may be a bolt that screws into the nut that replaces the driveshaft head, and the bolt and nut may attached top housing 204 to a mechanical link is shaft 106 linking top housing 204 to shaft 106 (FIG. 1), so that motor 202 turns top housing 204. In another embodiment, the socket of top housing 204 may be located on the interior of top housing 204 instead of the exterior.

Each embodiment disclosed herein may be used or otherwise combined with any of the other embodiments disclosed. Any element of any embodiment may be used in any embodiment.

Although the invention has been described in detail for the purpose of illustration, it is to be understood that such detail is solely for that purpose and that variations can be made therein by those skilled in the art without departing from the spirit and scope of the invention as defined by the claims. In other words, although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

1. A device comprising:
a trimmer head including at least
a first side having at least
one or more exit ports for removing one or more trimmer lines, the one or more trimmer, and
a structure that engages a driveshaft;
a periphery including at least one entrance port for loading the trimmer lines;
a second side without any exit ports or entrance ports for the trimmer lines;
one or more walls, within the interior of the trimmer head, forming one or more passage ways guiding the one or more trimmer lines from the one or more entrance ports to the one or more exit ports; and
one or more gripping mechanisms
that are mounted along the one or more passageways,
that grip the one or more trimmer lines, hindering the one or more trimmer lines from sliding in a direction towards the one or more entrance ports and away from the one or more exit ports, and
that allows the one or more trimmer lines to slide in a direction away from the one or more entrance ports towards the one or more exit ports.

2. The device of claim 1, the one or more gripping mechanisms being mounted at one or more locations that are closer to a pivot axis of the trimmer head than to a periphery of the trimmer head, the one or more gripping mechanisms being located close enough to the pivot axis that the trimmer head does not vibrate during operation of the trimmer head even while those of the one or more trimmer lines that function properly are attached to the trimmer head at locations that are not symmetrically distributed about the pivot axis and are that are not equiangularly distributed about the pivot axis.

3. The device of claim 1,
the trimmer head including at least a hole running through the trimmer head, the trimmer head having at least
a first entrance to the hole at one end of the trimmer head having a contoured socket, which will be referred to as a trimmer head socket, and
a second entrance to the hole at another other end of the trimmer head;
the device further comprising:
a driveshaft having at least one end that is contoured to mate with the trimmer head socket, the driveshaft engaging the trimmer head such that as the driveshaft turns, the trimmer head turns with the driveshaft, the hole in the trimmer head being for receiving the driveshaft, the driveshaft being inserted into the trimmer head via the first entrance to the hole;
a spacer preventing the trimmer head from being operated at below a height determined by a size of the spacer and a distance from the spacer to a point in a plane in which the one or more trimmer lines extend from the trimmer head, the spacer including at least a cylindrical body having at least a first and second end, between the first end and the second end is a surface with a hole, at the second end is a contoured socket, which will be referred to as a spacer socket, and within the spacer socket is the surface with the hole; and
a bolt having
a noncircular head that mates with the spacer socket, the head of the bolt being too large to fit through the hole in the surface with the hole of the spacer,
a cylindrical body protruding from the head, the cylindrical body being narrow enough to fit through the hole in the surface with the hole of the spacer, and
an end of the cylindrical body opposite the head is contoured to connect to the contoured portion of the driveshaft, the spacer being connectable to the trimmer head by connecting the contoured end of the bolt to the contoured end of the driveshaft, with the bolt inserted into the spacer via the noncircular socket through the hole in the surface with the hole, wherein the bolt may be connected to the driveshaft by turning the spacer without use of a wrench.

4. The device of claim 3, the body of the spacer having at least a cylindrical shape.

5. The device of claims 3, the spacer having at least a grip on sides of the spacer that facilitate turning the spacer to screw the bolt into the trimmer head.

6. The device of claim 1, the trimmer head also including a housing having at least two members, which are a top housing and a bottom housing, the first side being located on the top housing, the structure on the first side including a socket that is contoured, and the second side being located on the bottom housing;
the device further comprising a driveshaft including at least a cylindrical shaft and a head contoured to mate with the socket.

7. The device of claim 1, the one or more passage ways being shaped to guide the one or more trimmer lines such that the one or more trimmer lines make an angle of between 45 and 90 degrees with a surface of a plane that is perpendicular to an axis of rotation of the trimmer head.

8. The device of claim 1, the trimmer head also including a housing having at least two members, which are a top housing and a bottom housing, the first side being located on the top housing, and the second side being located on the bottom housing.

9. The device of claim 8, the structure on the first side being a socket that is contoured, the device further comprising a driveshaft including at least a cylindrical shaft and a head contoured to mate with the socket.

10. The device of claim 8, one of the top housing and bottom housing having alignment pins and another of the top housing and bottom housing having alignment holes that receive the alignment pins.

11. The device of claim 1, the gripping mechanism including at least
one or more sliding clamps;
one or more chambers within the trimmer head within which the one or more sliding clamps are located;
one or more mechanical biases pushing the one or more sliding clamps into the passageway;
the one or more clamps each having one or more teeth that are angled to snag the one or more trimmer lines if the one or more trimmer lines move in a first direction, but not if the one or more trimmer lines move in a second direction.

12. The device of claim 11, the one or more mechanical biases being one or more springs.

13. The device of claims 11, the one or more mechanical biases, the one or more clamps, and the one or more chambers being located close enough to the center of the trimmer head that the trimmer head does not vibrate if one of the one or more trimmer lines breaks.

14. The device of claim 11, one of the one or more chambers and the one or more clamps having one or more pins and another of the one or more chambers and the one or more clamps having one or more slots to receive the one or more pins, the one or more pins, the one or more slots, and the one or more chambers guiding the one or more clamps as the one or more clamps slide.

15. The device of claim 1, further comprising an elongated shaft containing a mechanical link attached to the driveshaft, and the mechanical link linking the driveshaft to a motor, such that the motor turns the mechanical link, which causes the driveshaft to rotate.

16. The device of claim 1, the first side having legends indicating from where to unload the trimmer line from the trimmer head.

17. The device of claim 1, further comprising a plurality of fasteners holding the top housing to the bottom housing.

18. The device of claim 1, the one or more gripping mechanisms being mounted at locations that are closer to a pivot axis of the trimmer head than to a periphery of the trimmer head, the one or more gripping mechanisms being located close enough to the pivot axis that the trimmer head does not vibrate during operation of the trimmer head even while those of the one or more trimmer lines that function properly are attached to the trimmer head at locations that are not symmetrically distributed about the pivot axis and are that are not equiangularly distributed about the pivot axis;
the first side having legends indicating which ports to use for unloading the trimmer line from the trimmer head;
the one or more gripping mechanism including at least
one or more sliding clamps
one or more chambers within the trimmer head within which the one or more sliding clamps are located,
one or more mechanical biases pushing the one or more sliding clamps into the one or more passageways
each of the one or more sliding clamps each having one or more teeth that are angled to snag a corresponding one of the one or more trimmer lines if the corresponding one of the one or more trimmer lines moves in a first direction, but not if the corresponding one of the one or more trimmer lines moves in a second direction.
the one or more mechanical biases, the one or more clamps, and the one or more chambers being located close enough to the center of the trimmer head that the head does not vibrate if a trimmer line breaks,
one of either the one or more chambers or the one or more clamps having pins and another of either the one or more chamber or the one or more clamps having slots to receive the pins, the one or more pins, one or more slots, and one or more chambers guiding the one or more clamps as the one or more clamps slide,
the one or more passage ways being shaped to guide the one or more trimmer lines such that the one or more trimmer lines make an angle of between 45 and 90 degrees with a surface of a plane that is perpendicular to an axis of rotation of the trimmer head,
the trimmer head including at least
a housing having at least two members, which are
a top housing, the first side being located on the top housing, the top housing having a socket that is contoured, which will be referred to as the trimmer head socket, and
a bottom housing, the second side being located on the bottom housing,
a hole running through the trimmer head, the trimmer head having at least
a first entrance to the hole at a bottom of the trimmer head socket, and
a second entrance to the hole at the other end of the trimmer head in the bottom housing,
one or more fasteners fastening the top housing to the bottom housing;
the device further comprising:
a driveshaft having at least one end that is contoured, the driveshaft engaging the driveshaft such that as the driveshaft turns the trimmer head turns with the driveshaft, the hole in the trimmer head being for receiving the driveshaft, the driveshaft being inserted into the trimmer head via the first entrance to the hole;
a spacer for preventing the trimmer head form being operated at below height determined by a size of the spacer and a distance from the spacer to a point in a plane in which the one or more trimmer lines extend from the trimmer head, the spacer including at least a cylindrical body having at least a first end, second end, and cylindrical walls, between the first end than the second end is a surface with a hole, at the second end is a contoured socket, which will be referred to as the spacer socket, and within the spacer socket is the surface with the hole,
the spacer having at least a grip on the cylindrical sides of the grip that facilitate turning the spacer to screw the bolt into the trimmer head; and
a bolt having
a noncircular head that mates with the socket, the head of the bolt being too large to fit through the hole in the surface with the hole of the spacer,
a cylindrical body protruding from the head, the cylindrical body being narrow enough to fit through the hole in the surface with the hole of the spacer, and
an end of the cylindrical body opposite the head is contoured to connect to the contoured portion of the driveshaft, the spacer being connectable to the trimmer head by connecting the contoured end of the bolt to the contoured end of the driveshaft, with the bolt instead into the spacer via the noncircular socket through the hole in the surface with the hole, wherein the bolt may connected to the driveshaft by turning the spacer without use of a wrench.

19. A method of unloading the device of claim 1, comprising pulling at least one of the one or more trimmer lines out from at least one of the one or more exit ports.

20. A device comprising:
a trimmer head including at least
one exit port for removing trimmer line;
one entrance port for loading the trimmer line;
one or more walls, within the interior of the trimmer head, forming a passage way guiding the trimmer line from the entrance port to the exit port; and
a gripping mechanism
that is mounted along the passageway at a location that is closer to a pivot axis of the trimmer head than to a periphery of the trimmer head, the gripping mechanism being located close enough to the pivot axis that the trimmer head does not vibrate during operation of the trimmer head even while the trimmer line is not symmetrically distributed about the pivot axis and is not equiangularly distributed about the pivot axis,
that grips the trimmer line, hindering the trimmer line from sliding in a direction towards the entrance port and away from the exit port, and
allows the trimmer line to slide in a direction away from the entrance port towards the exit port.

21. A device comprising:
a driveshaft having at least one end that is contoured;
a trimmer head engaging the driveshaft such that as the driveshaft turns the trimmer head turns with the driveshaft, the trimmer head including at least a hole running through the trimmer head for receiving the driveshaft, the trimmer head having at least
a first entrance to the hole at one end of the trimmer head where the driveshaft is inserted, and
a second entrance to the hole at the other end of the trimmer head;
a spacer for preventing the trimmer head from being operated at below a height determined by a size of the spacer and a distance from the spacer to a point in a plane at which trimmer line extends from the trimmer head, the spacer including at least a cylindrical body having at least a first and second end, between the first end and the second end is a surface with a hole, at the second end is a noncircular socket, and within the socket is the surface with the hole; and
a bolt having
a noncircular head that mates with the socket, the head of the bolt being too large to fit through the hole in the surface with the hole of the spacer,
a cylindrical body protruding from the head, the cylindrical body being narrow enough to fit through the hole in the surface with the hole of the spacer, and
an end of the cylindrical body opposite the head is contoured to connect to the contoured portion of the driveshaft, the spacer being connectable to the trimmer head by connecting the contoured end of the bolt to the contoured end of the driveshaft, with the bolt inserted into the spacer via the noncircular socket through the hole in the surface with the hole, wherein the bolt may be connected to the driveshaft by turning the spacer without use of a wrench.
